(19) United States
(12) Patent Application Publication
(10) Pub. No.: US 2025/0210704 A1
(43) Pub. Date: Jun. 26, 2025

(54) NEW POLYMERS FOR BATTERY APPLICATIONS

(71) Applicant: OXFORD UNIVERSITY INNOVATION LIMITED, Oxford (GB)

(72) Inventors: Charlotte WILLIAMS, Oxford (Oxfordshire) (GB); Georgina GREGORY, Oxford (Oxfordshire) (GB); Peter BRUCE, Oxford (Oxfordshire) (GB); Mauro PASTA, Oxford (Oxfordshire) (GB)

(21) Appl. No.: 18/845,899

(22) PCT Filed: Mar. 16, 2023
(86) PCT No.: PCT/GB2023/050634

§ 371 Date: Sep. 11, 2024

(30) Foreign Application Priority Data
Mar. 17, 2022 (GB) 2203752.7

(51) Int. Cl. H01M 10/0565; H01M 4/02; H01M 4/137; H01M 4/60

(52) U.S. Cl. CPC H01M 10/0565; H01M 4/137; H01M 4/606; H01M 2004/028; H01M 2300/0082

(57) ABSTRACT

New block polymers are described, as well as processes for preparing them using a ring-opening copolymerisation technique. Also described are electrolytes, cathodes and batteries comprising the polymers.

### INTRODUCTION

The present invention relates to polymers for use in batteries and battery components. The invention also relates to batteries and battery components (e.g., electrolytes and cathodes) comprising the polymers, as well as to processes for preparing the polymers and battery components.

### BACKGROUND OF THE INVENTION

Rechargeable lithium-ion batteries (LIBs) are ubiquitous in modern technology, powering mobile phones, personal computers and an emerging field of wearable electronics. However, next-generation rechargeable batteries are critical to transforming large-scale grid-energy storage (from sustainable wind and solar sources) and the phasing out of petrol/diesel cars through the widespread commercialization of affordable and practical electric vehicles.¹ New battery technologies must meet stricter safety requirements, lower production costs, and achieve enhanced performance such as higher capacities (10,000×portable electronics), faster charging (<30 mins), and higher energy densities (>250 Whkg⁻¹).² Polymers can play an essential role in battery devices acting as electrolytes, binders, interface modifiers, separators and packaging.

Increasingly, however, advanced functional polymer materials are required that combine conductivity, stability, adhesive and mechanical properties (elastomeric torobust plastics) and processability.³⁻¹⁰

To improve battery safety, replacing flammable liquid electrolytes in commercial LIBs with solid-state alternatives is widely regarded. Solid-state electrolytes can also enable use of higher-voltage cathode materials (>3.5V) to enhance battery capacities and allow^{5,11} the use of lithium metal anodes to attain higher energy densities. Despite significant progress in all-solid-state batteries, an outstanding challenge remains to maintain physical particle-particle contact of all the solid components (a pre-requisite for charge movement) without applying unpractical high pressures (typically 50 MPa). For example, cathode materials such as LiNiₓMn_{y}Co_{z}O₂ (NMC) are composed of sheets of cobalt oxide with intercalated lithium ions and undergo a volume change (as much as 10%) during battery charging/discharging as a result of (de)intercalation of Li-ions.¹²⁻¹³ Repeated cycling subsequently leads to loss of solid-solid contact and deterioration of battery performance.

To avoid applying unpractical pressures, the use of well-designed polymers to accommodate these volume changes is increasingly coming into focus to enable the practical realization of all-solid-state batteries (ASSBs).^{14,15}, Polyvinylidene fluoride (PVDF) is a common polymer binder used in cathode materials due to its high chemical stability, but it lacks the elasticity to accommodate deformations.^{16,17} The use of elastomers such as styrenic block copolymers (SBS and SEBS) has shown promise in improving the capacity retention of LIBs with cycle number that typically diminishes due to volume changes.¹⁸ However, the low polarity of these hydrocarbon polymer backbones means they show poor attachment to the inorganic electrode materials, resulting in an unstable mechanical interface/loss of electrode integrity/failure of contacts. Computational work by Carter and coworkers¹⁹ suggests delamination of these interfaces is induced when electrode particles undergo as little as 7.5% volume charge during (de)lithiation.

To date, poly(ethylene oxide) (PEO) has been the most successful and extensively studied polymer electrolyte owing to its ability for coordinating Li-ions and solvating a variety of lithium salts with ion transport by hopping between oxygen sites being facilitated by the high chain flexibility of PEO related with its low glass transition (T_{g}^{˜}-64° C.).^{20,21} However, the semi-crystalline nature of PEO (70-84% at room temperature) limits its room-temperature ionic conductivity (10⁻⁸-10⁻⁷ S cm⁻¹) and mechanical properties, leading to brittle materials.

In spite of the advances made in this field, there remains a need for structurally well-defined polymeric materials having electrochemical and mechanical properties making them suitable for use in batteries and battery components.

The present invention was devised with the foregoing in mind.

### SUMMARY OF THE INVENTION

According to a first aspect of the present invention there is provided a polymer having a structure according to Formula I:

A-B-A (I)
wherein
A is a polycarbonate block; and
B is a polyether block.

According to a second aspect of the present invention there is provided a process for the preparation of a polymer, the process comprising the steps of:
(a) providing a polyether having a hydroxy terminal group at each end; and
(b) growing a polycarbonate on both ends of the polyether by ring-opening copolymerisation of:
(i) an epoxide or an oxetane, and (ii) carbon dioxide.

According to a third aspect of the present invention there is provided a polymer obtained, directly obtained or obtainable by the process of the second aspect.

According to a fourth aspect of the present invention there is provided an electrolyte comprising a mixture of a polymer of the first or third aspect and a metal salt.

According to a fifth aspect of the present invention there is provided a process for making an electrolyte, the process comprising the step of:
(i) preparing a polymer according to the process of the second aspect; and
(ii) mixing the polymer with a metal salt.

According to a sixth aspect of the present invention there is provided a cathode for a battery, the cathode comprising a polymer of the first or third aspect, and/or an electrolyte of the fourth aspect.

According to a seventh aspect of the present invention there is provided a battery comprising a polymer of the first or third aspect, an electrolyte of the fourth aspect, and/or a cathode of the sixth aspect.

According to an eighth aspect of the present invention there is provided a use of a polymer of the first or third aspect in the manufacture of a battery or a battery component.

### DETAILED DESCRIPTION OF THE INVENTION

### Definitions

The term “(m-nC)” or “(m-nC) group” used alone or as a prefix, refers to any group having m to n carbon atoms.

The term “alkyl” as used herein refers to straight or branched chain alkyl moieties, typically having 1, 2, 3, 4, 5 or 6 carbon atoms. This term includes reference to groups such as methyl, ethyl, propyl (n-propyl or isopropyl), butyl (n-butyl, sec-butyl or tert-butyl), pentyl, hexyl and the like. Most suitably, an alkyl may have 1, 2, 3 or 4 carbon atoms.

The term “alkylene” as used herein refers to a divalent equivalent of an alkyl group as described above.

The term “alkenyl” as used herein refers to straight or branched chain alkenyl moieties, typically having 1, 2, 3, 4, 5 or 6 carbon atoms. The term includes reference to alkenyl moieties containing 1, 2 or 3 carbon-carbon double bonds (C═C). This term includes reference to groups such as ethenyl (vinyl), propenyl (allyl), butenyl, pentenyl and hexenyl, as well as both the cis and trans isomers thereof.

The term “alkynyl” as used herein refers to straight or branched chain alkynyl moieties, typically having 1, 2, 3, 4, 5 or 6 carbon atoms. The term includes reference to alkynyl moieties containing 1, 2 or 3 carbon-carbon triple bonds (C═C). This term includes reference to groups such as ethynyl, propynyl, butynyl, pentynyl and hexynyl.

The term “alkoxy” as used herein refers to —O-alkyl, wherein alkyl is a straight or branched chain and comprises 1, 2, 3, 4, 5 or 6 carbon atoms. In one class of embodiments, alkoxy has 1, 2, 3 or 4 carbon atoms. This term includes reference to groups such as methoxy, ethoxy, propoxy, isopropoxy, butoxy, tert-butoxy, pentoxy, hexoxy and the like.

The term “aryl” or “aromatic” as used herein means an aromatic ring system comprising 6, 7, 8, 9 or 10 ring carbon atoms. Aryl is often phenyl but may be a polycyclic ring system, having two or more rings, at least one of which is aromatic. This term includes reference to groups such as phenyl, naphthyl and the like.

The term “aryl-(m-nC)alkyl” means an aryl group covalently attached to a (m-nC)alkylene group, both of which are described herein. Examples of aryl-(m-nC)alkyl groups include benzyl, phenylethyl, and the like.

The term “heteroaryl” or “heteroaromatic” means an aromatic mono-, bi-, or polycyclic ring incorporating one or more (for example 1-4, particularly 1, 2 or 3) heteroatoms selected from nitrogen, oxygen or sulfur. Examples of heteroaryl groups are monocyclic and bicyclic groups containing from five to twelve ring members, and more usually from five to ten ring members. The heteroaryl group can be, for example, a 5- or 6-membered monocyclic ring or a 9- or 10-membered bicyclic ring, for example a bicyclic structure formed from fused five and six membered rings or two fused six membered rings. Each ring may contain up to about four heteroatoms typically selected from nitrogen, sulfur and oxygen. Typically, the heteroaryl ring will contain up to 3 heteroatoms, more usually up to 2, for example a single heteroatom.

The term “heteroaryl-(m-nC)alkyl” means an heteroaryl group covalently attached to a (m-nC)alkylene group, both of which are described herein.

The term “carbocyclyl”, “carbocyclic” or “carbocycle” means a non-aromatic saturated or partially saturated monocyclic, or a fused, bridged, or spiro bicyclic carbocyclic ring system(s). Monocyclic carbocyclic rings contain from about 3 to 12 (suitably from 3 to 7) ring atoms. Bicyclic carbocycles contain from 7 to 17 carbon atoms in the rings, suitably 7 to 12 carbon atoms, in the rings. Bicyclic carbocyclic rings may be fused, spiro, or bridged ring systems.

The term “heterocyclyl”, “heterocyclic” or “heterocycle” means a non-aromatic saturated or partially saturated monocyclic, fused, bridged, or spiro bicyclic heterocyclic ring system(s). Monocyclic heterocyclic rings contain from about 3 to 12 (suitably from 3 to 7) ring atoms, with from 1 to 5 (suitably 1, 2 or 3) heteroatoms selected from nitrogen, oxygen or sulfur in the ring. Bicyclic heterocycles contain from 7 to 17 member atoms, suitably 7 to 12 member atoms, in the ring. Bicyclic heterocyclic(s) rings may be fused, spiro, or bridged ring systems.

The term “halogen” or “halo” as used herein refers to F, Cl, Br or I. In a particular, halogen may be F or Cl, of which Cl is more common.

The term “haloalkyl” is used herein to refer to an alkyl group in which one or more hydrogen atoms have been replaced by halogen (e.g. fluorine) atoms. Often, haloalkyl is fluoroalkyl. Examples of haloalkyl groups include —CH₂F, —CHF₂ and —CF₃.

The term “substituted” as used herein in reference to a moiety means that one or more, especially up to 5. Preferably, “substituted” as used herein in reference to a moiety means that 1, 2 or 3, of the hydrogen atoms in said moiety are replaced independently of each other by the corresponding number of the described substituents. Even more preferred, “substituted” as used herein in reference to a moiety means that 1 or 2, of the hydrogen atoms in said moiety are replaced independently of each other by the corresponding number of the described substituents. The term “optionally substituted” as used herein means substituted or unsubstituted.

It will, of course, be understood that substituents are only at positions where they are chemically possible, the person skilled in the art being able to decide (either experimentally or theoretically) without inappropriate effort whether a particular substitution is possible

Throughout the entirety of the description and claims of this specification, where subject matter is described herein using the term “comprise” (or “comprises” or “comprising”), the same subject matter instead described using the term “consist of” (or “consists of” or “consisting of”) or “consist essentially of” (or “consists essentially of” or “consisting essentially of”) is also contemplated.

Throughout the description and claims of this specification, the singular encompasses the plural unless the context otherwise requires. In particular, where the indefinite article is used, the specification is to be understood as contemplating plurality as well as singularity, unless the context requires otherwise.

Features described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any of the specific embodiments recited herein. The invention extends to any novel one, or any novel combination, of the features disclosed in this specification (including any accompanying claims, abstract and drawings), or to any novel one, or any novel combination, of the steps of any method or process so disclosed.

Unless otherwise specified, where the quantity or concentration of a particular component of a given product is specified as a weight percentage (wt. % or % w/w), said weight percentage refers to the percentage of said component by weight relative to the total weight of the product as a whole. It will be understood by those skilled in the art that the sum of weight percentages of all components of a product will total 100 wt. %. However, where not all components are listed (e.g. where a product is said to “comprise” one or more particular components), the weight percentage balance may optionally be made up to 100 wt % by unspecified ingredients.

### Polymers

In a first aspect, the present invention provides a polymer having a structure according to Formula I:

A-B-A (I)
wherein
A is a polycarbonate block; and
B is a polyether block.

Through detailed investigations, the inventors have devised new tri-block copolymers having electrochemical and mechanical properties making them suitable for use in batteries and battery components (e.g. electrolytes and cathodes). The polymers can be straightforwardly and flexibly prepared using environmentally friendly raw materials by a ring opening copolymerisation (ROCOP) technique, which affords a high degree of control over the polymer's structure, thereby allowing the polymer's properties to be tuned according to a particular application.

Each block A may comprise n number of repeating units, wherein each n is 1 to 1000. Suitably, each n is 2 to 300.

Block B may comprises m number of repeating units, wherein m is 5-10,000. Suitably, m is 15-3000.

The tri-block copolymers of the invention are suitably block phase-separated (as opposed to block phase-miscible). Phase separation of the blocks within the copolymer may be indicated by the presence of two distinct glass transition temperatures (T_{g}); one for block A and one for block B.

Block A may have a glass transition temperature (T_{g}) that is ≥20° C. (e.g. 20-120° C.). Suitably, block A has a glass transition temperature (T_{g}) that is ≥60° C. More suitably, block A has a glass transition temperature (T_{g}) that is ≥80° C. Most suitably, block A has a glass transition temperature (T_{g}) that is 90-115° C.

Block B may have a glass transition temperature (T_{g}) that is ≤20° C. (e.g. −60 to 20° C.). Suitably, block B has a glass transition temperature (T_{g}) that is ≤0° C. More suitably, block B has a glass transition temperature (T_{g}) that is ≤−25° C. Most suitably, block B has a glass transition temperature (T_{g}) that is −50 to −30° C.

In embodiments, block A has a glass transition temperature (T_{g}) that is 90-115° C. and block B has a glass transition temperature (T_{g}) that is −50 to −30° C.

Block B may have a dispersity (Ð) of 51.30. Alternatively/additionally, the polymer itself may have a dispersity (Ð) of 51.30.

A proportion of the A and/or B block repeating units may independently comprise a pendant neutral functional group, FG_{N}, and/or a pendant anionic functional group, FG_{A}. Such functional groups can be used to tune the properties (e.g., adhesivity) of the polymer according to the desired battery application. For example, functional groups that are able to participate in hydrogen-bonding can improve the polymer's ability to withstand volume changes that occur during (de)lithiation. Exemplary pendant neutral functional groups, FG_{N} include —P(O)(OH)₂, —COOH, —OH, —SO₃H, —NH₂, —C(O)NH₂, —F, —CF₃ and —CN. Exemplary pendant anionic functional groups, FG_{A} include —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻. The skilled person will be familiar with chemical techniques by which such functional groups can be introduced into some or all of the repeating units forming blocks A and/or B. Suitably, a proportion (e.g., some, but not all) of the A block repeating units comprises a group FG_{N} and/or a group FG_{A}.

In embodiments, a proportion of the A and/or B block repeating units comprise a neutral functional group being —P(O)(OH)₂. The inclusion of phosphonate groups, which can participate in hydrogen-bonding, within the polymer can improve the polymer's ability to withstand volume changes that occur during (de)lithiation.

Block A may be amorphous. Amorphous polymers have no observable melting point when analysed by differential scanning calorimetry. Suitably, blocks A and B are amorphous.

The polymer may have a molecular weight (Mₙ) of 2-150 kg mol⁻¹. Suitably, the polymer has a molecular weight (Mₙ) of 3-80 kg mol⁻¹. More suitably, the polymer has a molecular weight (Mₙ) of 10-60 kg mol⁻¹. The molecular weight (Mₙ) of the polymer can be determined by 1H NMR integration.

Block B may have a molecular weight (Mₙ) of 0.8-150 kg mol⁻¹. Suitably, block B has a molecular weight (Mₙ) of 3-110 kg mol⁻¹. More suitably, block B has a molecular weight (Mₙ) of 4-60 kg mol⁻¹. More suitably, block B has a molecular weight (Mₙ) of 5-45 kg mol⁻¹. In some particular embodiments, block B has a molecular weight (Mₙ) of 6-12 kg mol⁻¹. In other particular embodiments, block B has a molecular weight (Mₙ) of 30-40 kg mol⁻¹. The molecular weight (Mₙ) of the polymer can be determined by SEC.

The polymer may comprise 10-80 wt % of block A. The wt % of block A recited herein refers to the total amount of such blocks present with the polymer. Suitably, the polymer comprises 20-75 wt % of block A. In some particular embodiments, the polymer comprises 20-40 wt % of block A. In other particular embodiment, the polymer comprises 50-75 wt % of block A. The wt % of block within the polymer can be determined by relative ¹H NMR integration of block A and B signals.

In embodiments, block B has a molecular weight (Mₙ) of 30-40 kg mol⁻¹ and the polymer comprises 60-80 wt % of block A. Suitably, the polymer comprises 65-75 wt % of block A.

In embodiments, block B has a molecular weight (Mₙ) of 30-40 kg mol⁻¹ and the polymer comprises 20-40 wt % of block A. Suitably, the polymer comprises 22-30 wt % of block A

In embodiments, block B has a molecular weight (Mₙ) of 6-12 kg mol⁻¹ and comprises 25-55 wt % of block A. Suitably, the polymer comprises 32-42 wt % of block A.

Blocks A may have a structure according to Formula A-i:

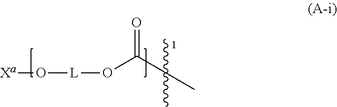

wherein
[symbol] ¹ denotes the point of attachment to B;
X^{a} is an end group; and
L is a linking group separating the two oxygen atoms to which it is attached by a distance of 2-3 carbon atoms.

It will be understood by those of skill in the art that the use of square brackets denotes a repeating unit within the polymeric block.

Repeating units of the type depicted in Formula A-i can be prepared by ROCOP of CO₂ with an epoxide (e.g., where L separates the two oxygen atoms by a distance of 2 oxygen atoms) or an oxetane (e.g., where L separates the two oxygen atoms by a distance of 3 oxygen atoms).

It will be appreciated that a variety of epoxides and oxetanes can be used to form the repeating unit in Formula A-i, some of which are described herein in relation to the second aspect of the invention.

L is suitably a linking group that separates the two oxygen atoms to which it is attached by a distance of 2 carbon atoms. The two carbon atoms may form part of a ring. The ring may be a 5- to 7-membered carbocyclyl or heterocyclyl ring. Most suitably, the ring is a 6-membered carbocyclyl ring.

It will be understood that the end group X^{a} can take a variety of forms. Often, X^{a} is H.

Block A may have a structure according to Formula A-ii:

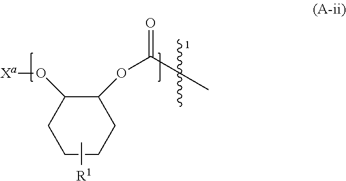

wherein
[symbol] ¹ denotes the point of attachment to block B;
X^{a} is an end group; and
each R¹ is independently absent or a group —X—(R²)ᵥ, in which
each R² is independently a pendant neutral functional group FG_{N} or a pendant anionic functional group FG_{A} as defined hereinbefore;
each v is independently 0 or 1; and
each X is (when v is 1) a linking group (e.g. a divalent group) that links R² to the cyclohexyl ring, or is (when v is 0) a terminal (e.g., monovalent) group.

Repeating units of the type depicted in Formula A-ii can be prepared by ROCOP of CO₂ with a cyclohexene oxide. Since a variety of substituted epoxides of this type are readily available, or can be straightforwardly prepared by known chemistries, it will be appreciated that R¹, when present, can take a variety of forms.

When v is 0, X is a terminal group. For example, X may be a vinyl group that was present on the cyclohexyl ring during polymerisation. Alternatively, X can be a linking group (when v is 1) that connects the cyclohexyl ring to one of the aforementioned functional groups. Continuing with the example of a vinyl group present on the cyclohexyl ring during polymerisation, some of these vinyl groups can, following polymerisation, be reacted with a reagent comprising a R² group (e.g., 2-mercaptoethyl phosphonic acid) to yield a group —X—R², where X is a linking group —CH₂CH₂SCH₂CH₂— and R² is a FG_{N} —P(O)(OH)₂. In this sense, it will be appreciated that block A may comprise a mixture of (divalent) linking and (monovalent) terminal groups X. Furthermore, it will be appreciated that the specific groups mentioned in this paragraph are provided solely for the purpose of illustration, and that a person of ordinary skill in the art will recognise that X can take a variety of forms. Typically, X will be composed of fewer than 80 atoms, more suitably fewer than 40 atoms, even more suitably fewer than 20 atoms.

In embodiments, R¹ is absent, or is

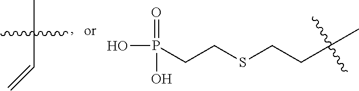

Suitably, the polymer comprises 1-10 wt % (relative to polymer mass), more suitably 3-9 wt %, most suitably 5-7 wt % of groups:

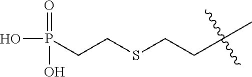 [SMILES: *CCSCCP(=O)(O)O]

Block B may comprise a poly(ethylene oxide) backbone. Optionally, a proportion of the B block repeating units comprise a side chain independently selected from (1-2C)alkyl, —CH₂OCH₂CH═CH and alkyl-terminating poly(ethylene oxide).

Block B may be composed of poly(ethylene oxide), poly(propylene oxide), poly(allyl glycidyl ether) or a copolymer of two or more thereof. Most suitably, block B is composed of poly(ethylene oxide).

In embodiments, the polymer has a structure according to Formula (IA):

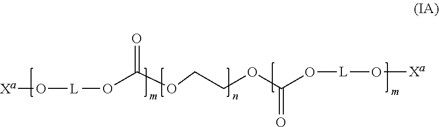

wherein L, X^{a}, m and n are as defined hereinbefore.

In embodiments, the polymer has a structure according to Formula (IB):

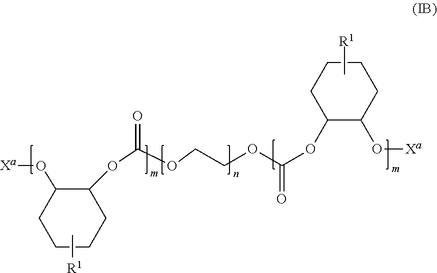

wherein X^{a}, R¹, m and n are as defined hereinbefore.

In a second aspect, the present invention provides a process for the preparation of a polymer, the process comprising the steps of:
(a) providing a polyether having a hydroxy terminal group at each end; and
(b) growing a polycarbonate on both ends of the polyether by ring-opening copolymerisation of:
(i) an epoxide or an oxetane, and (ii) carbon dioxide.

The tri-block copolymers of the first aspect can be straightforwardly prepared by ROCOP reaction. The use of CO₂ as a reagent in ROCOP is particularly beneficial from an environmental standpoint.

The dihydroxy polyether provided in step (a) serves as a difunctional chain transfer agent initiator for the ROCOP reaction in step (b). It will be understood that the hydroxy groups are located at the ends of the polyether chain.

The polyether provided in step (a) may be any of those polyethers, and/or have any of those properties (e.g., molecular weight (Mₙ), glass transition temperature (T_{g}), dispersity (Ð), and/or number of repeating units (m)) recited hereinbefore in relation to block B of the polymer of the first aspect. Additionally/alternatively, the polycarbonate grown in step (b) may be any of those polycarbonates, and/or have any of those properties (e.g., glass transition temperature (T_{g}) and/or number of repeating units (n)) recited hereinbefore in relation to block A of the polymer of the first aspect. Additionally/alternatively, the tri-block copolymer prepared by the process may be any of those polymers, and/or have any of those properties (e.g., wt % of block A and/or molecular weight (Mₙ)) recited hereinbefore in relation to the polymer of the first aspect.

The process can be conducted in the presence of a suitable catalyst. Catalysts that are able to catalyse the ROCOP of an epoxide/oxetane with CO₂ are known in the art. Suitably, the catalyst is a heterodinuclear catalyst, such as a Mg(II)Co(II) complex. A non-limiting example of a catalyst capable of performing step (b) is:

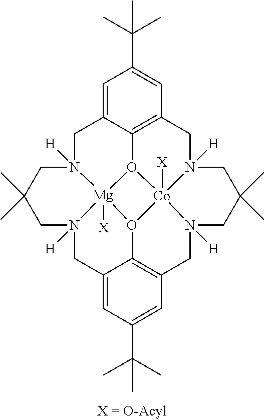

The process may further comprise an additional step of:
(c) modifying a proportion of the polycarbonate and/or polyether repeating units by introducing a pendant neutral functional group, FG_{N} and/or a pendant anionic functional group, FG_{A} as described hereinbefore in relation to the first aspect. Suitably, step (c) comprises modifying a proportion of the polycarbonate repeating units.

As described hereinbefore in relation to the first aspect, the epoxide/oxetane used in step (b) can take a variety of forms. Suitable oxetanes include 1,3-propylene oxide, 2,2-dimethyl oxetane and 3,3-dimethyl oxetane. Suitable epoxides include 2,3-dimethyl oxirane, terminal epoxides, glycidyl ethers and cyclic epoxides.

Terminal epoxides may have the structure:

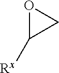

wherein R^{x} is selected from hydrogen, (1-4C)alkyl, (2-4C)alkenyl, (1-4C)haloalkyl, aryl, aryl-(1-2C)alkyl, —(OCH₂CH₂)ᵣOMe and —(CH₂)ₛC(O)O—R^{x1}, in which r is 1-10, s is 0-6 and R^{x1} is (1-5C)alkyl or aryl-(1-2C)alkyl. Particular non-limiting examples of R^{x} include hydrogen, methyl, ethyl, phenyl, —CH₂Cl, —CH═CH₂, —CH₂C(O)OtBu, —C(O)OBn, —(CH₂)₁₋₄C(O)OMe and —(OCH₂CH₂)₁₋₆OMe.

Glycidyl ethers may have the structure:

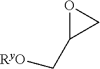

wherein R^{y} is selected from hydrogen, (1-4C)alkyl, (2-4C)alkenyl, (2-4C)alkynyl and —(CH₂)ₜR^{y1}, in which t is 0-4 and R^{y1} is aryl, heteroaryl, carbocyclyl or heterocyclyl, wherein any ring in R^{y} is optionally substituted with one or more groups R^{y2}, and any (1-4C)alkyl in R^{y} is optionally substituted with R^{y3}; each R^{y2} being independently selected from (1-3C)alkyl and nitro, and R^{y3} being (1-4C)alkoxy or aryloxy. Particular non-limiting examples of R^{y} include hydrogen, (1-4C)alkyl, —CH₂OCH₂CH₃, —CH₂O—CH(CH₃)₂, —CH₂—O—C₆H₅ and:

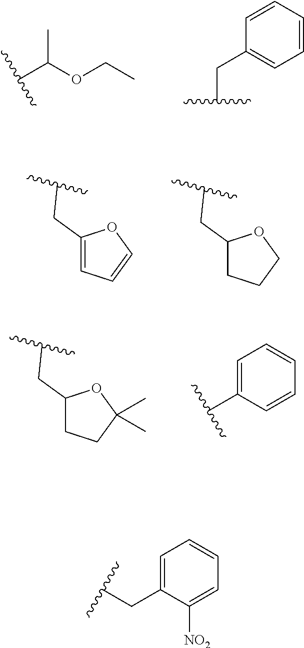

Cyclic epoxides may have the structure:

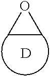

wherein D is a 5- to 7-membered carbocyclic or heterocyclic ring that is optionally fused or spiro-linked to 1 or 2 rings E, wherein each E is independently selected from carbocyclyl, heterocyclyl, aryl and heteroaryl, and wherein any of rings D and E are optionally substituted with one or more substituents R^{Z}, each R^{Z} being independently selected from (1-4C)alkyl, (2-4C)alkenyl, —(CH₂)₁₋₂Si(OR^{z1})₃, —(CH₂)₁₋₂OSi(R^{z1})₃, and a group -L^{z1}-L^{z2}-R^{z2}, in which R^{z1} is (1-2C)alkyl, L^{z1} is absent or (1-3C)alkylene, L^{z2} is absent, —O— or —C(O)O— and R^{z2} is hydrogen, (1-6C)alkyl, (1-5C)haloalkyl, heterocyclyl, aryl or aryl-(1-2C)alkyl, wherein any ring in R^{z2} is optionally substituted with (1-3C)alkyl or oxo. Particular, non-limiting examples of cyclic epoxides include:

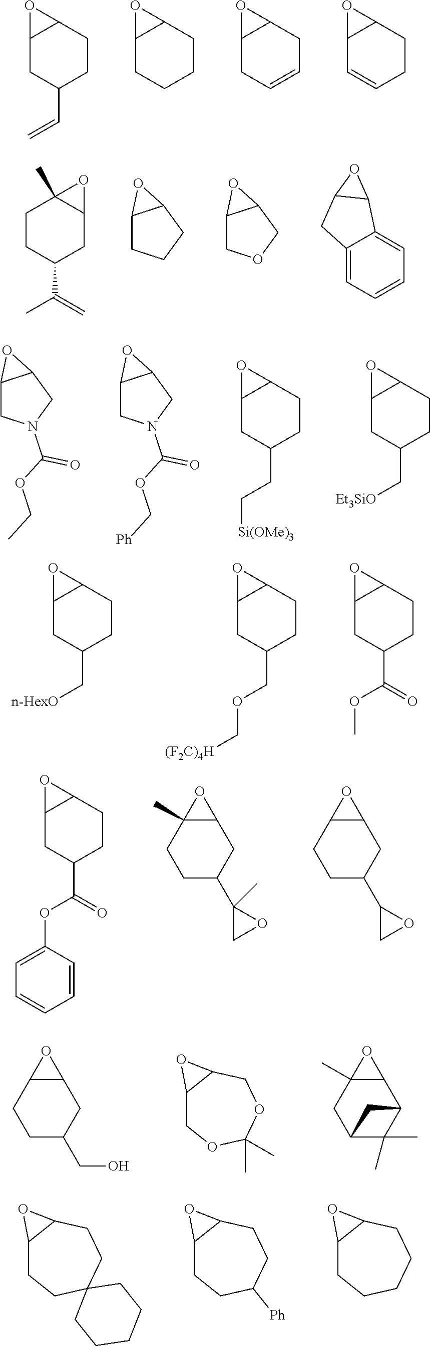

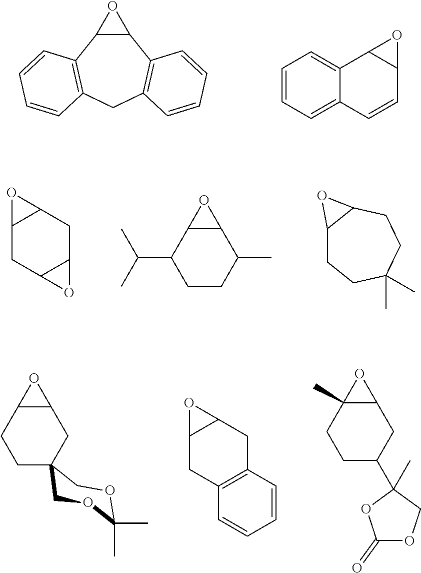

Suitably, the epoxide or oxetane is an epoxide. More suitably, the epoxide is a cyclic epoxide. Even more suitably, the epoxide is a 6-membered cyclic epoxide. Most suitably, the epoxide is selected from:

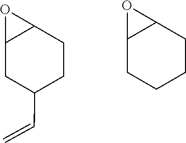

The polyether provided in step (a) may be dried prior to carrying out step (b). Suitably, the polyether provided in step (a) is dried under vacuum.

Step (b) may be conducted with a solvent (e.g., diethyl carbonate) or without a solvent (i.e., in neat epoxide/oxetane). Step (b) may be conducted at a temperature of 50-150° C. (e.g., 90-110° C.).

Step (b) is suitably conducted at a CO₂ pressure of <2 MPa. More suitably, step (b) is conducted at a CO₂ pressure of <1 MPa. Even more suitably, step (b) is conducted at a CO₂ pressure of <0.5 MPa. Most suitably, step (b) is conducted at a CO₂ pressure of 0.05-0.2 MPa.

In a third aspect, the present invention provides a polymer obtained, directly obtained or obtainable by a process of the second aspect.

### Battery Applications

In a fourth aspect, the present invention provides an electrolyte comprising a mixture of a polymer of the first or third aspect and a metal salt.

The inventors have surprisingly determined that the polymers described herein are particularly suitable for use in an electrolyte, such as for a battery. The electrolytes display good thermal stability, as well as elastomeric and mechanical properties. The electrolytes also demonstrate good ionic conductivity at ambient and elevated temperatures, as well as good oxidative stability, suggesting they are compatible with high voltage cathodes.

The metal salt may be a Na, Li or K salt. Suitably the metal salt is a Li salt.

The metal salt may have the formula M⁺ X⁻, wherein M⁺ is selected from Na⁺, Li⁺ and K⁺, and X⁻ is selected from BF₄⁻, ClO₄⁻, bis(fluorosulfonyl)imide, bis(trifluoromethanesulfonyl)imide, bis(oxalato)borate, a perfluoroalkylsulfonate (e.g., CF₃SO₃⁻), a polyfluoroalkyl sulfontate, PF₆, AsF₆⁻, cyano(trifluoromethanesulfonyl)imide, bis[(pentafluoroethyl)sulfonyl]imide, B(CN)₄⁻, 4,5-dicarbonitrile-1,2,3-triazole, perylene diimide, 4,5-dicyano-2-(trifluoromethyl)imidazolium and combinations of two or more thereof. Suitably, M⁺ is Li⁺ and/or X⁻ is bis(trifluoromethanesulfonyl)imide. Most suitably, M⁺ is Li⁺ and X⁻ is bis(trifluoromethanesulfonyl)imide.

The electrolyte may comprise 0.1-80 wt % of the metal salt. Suitably, the electrolyte comprises 15-70 wt % of the metal salt. Electrolytes in which the polymer comprises a greater quantity of block A may be able to accommodate an increased quantity of metal salt.

In embodiments, the polymer comprises 60-80 wt % of block A and the electrolyte comprises 15-75 wt % of metal salt. Suitably, the electrolyte comprises 40-75 wt % of metal salt. Most suitably, the electrolyte comprises 55-70 wt % of metal salt. The metal salt is suitably lithium bis(trifluoromethanesulfonyl)imide.

In embodiments, the polymer comprises 20-40 wt % of block A and the electrolyte comprises 15-40 wt % of metal salt. Most suitably, the electrolyte comprises 20-35 wt % of metal salt. The metal salt is suitably lithium bis(trifluoromethanesulfonyl)imide.

In particular embodiments, the electrolyte comprises 40-75 wt % (e.g. 55-70 wt %) of metal salt; the polymer comprises 60-80 wt % (e.g., 65-75 wt %) of block A; and block B has a molecular weight (Mₙ) of 30-40 kg mol⁻¹. The metal salt is suitably lithium bis(trifluoromethanesulfonyl)imide.

In particular embodiments, the electrolyte comprises 15-40 wt % (e.g. 20-35 wt %) of metal salt; the polymer comprises 20-40 wt % (e.g., 22-30 wt %) of block A; and block B has a molecular weight (Mₙ) of 30-40 kg mol⁻¹. The metal salt is suitably lithium bis(trifluoromethanesulfonyl)imide.

In particular embodiments, the electrolyte comprises 15-40 wt % (e.g. 20-35 wt %) of metal salt; the polymer comprises 25-55 wt % (e.g. 32-42 wt %) of block A; and block B has a molecular weight (Mₙ) of 6-12 kg mol⁻¹. The metal salt is suitably lithium bis(trifluoromethanesulfonyl)imide.

In a fifth aspect, the present invention provides a process for making an electrolyte, the process comprising the step of:
(i) providing a polymer according to the first or third aspect, or preparing a polymer according to the process of the second aspect; and
(ii) mixing the polymer with a metal salt.

Step (ii) may comprise mixing the polymer and metal salt in a solvent. Any suitable solvent may be used. A non-limiting example of a suitable solvent is anhydrous THF.

The process may further comprise a step (iii) of drying the mixture resulting from step (ii).

Suitably, the mixture is dried at a temperature of 50-80° C., optionally under vacuum.

In a sixth aspect, the present invention provides a cathode for a battery, the cathode comprising a polymer of the first or third aspect, and/or an electrolyte of the fourth aspect.

The cathode may be a composite cathode. The composite cathode may comprise a cathode material (e.g. LiNi_{0.8}Mn_{0.1}Co_{0.1}O₂, known as NMC811), an electrically conductive additive (e.g. carbon) and either or both of a polymer of the first aspect and an electrolyte of the fourth aspect. The cathode material, electrically conductive additive and polymer and/or electrolyte may be provided as a mixture (e.g., an intimate and substantially homogeneous mixture) within the cathode. Within the composite cathode, particles of the cathode material may be coated with the polymer of the first aspect and/or the electrolyte of the fourth aspect. The composite cathode may also comprise a ceramic electrolyte (e.g., argyrodite Li₆PS₅Cl)

The composite cathode can be prepared by mixing (e.g., ball milling) the powders of the composite cathode components under dry (i.e., solvent-free) conditions, and then forming the resulting powder into a composite cathode (e.g. by cold-pressing under increased pressure).

The composite cathode can also be prepared by mixing the powders of the composite cathode components in a liquid (e.g xylene) to form a slurry and then casting the slurry onto a current collector (e.g., an Al current collector) using, for example, a doctor blade.

The composite cathode can also be prepared by coating the polymer of the first aspect and/or the electrolyte of the fourth aspect onto particles of the cathode material. The coating technique is suitably conducted in solution, followed by drying of the coated particles. The coated particles of the cathode material may then be mixed with the other cathode components (e.g., electrically conductive additive), for example, by a dry or wet technique, as described above.

The cathode may be for an alkali metal ion or an alkali metal battery (e.g., Li, Na or K). The cathode is suitably for a Li-ion or Li-metal battery.

In a seventh aspect, the present invention provides a battery comprising a polymer of the first or third aspect, an electrolyte of the fourth aspect, and/or a cathode of the sixth aspect.

In one arrangement, the battery comprises an electrolyte of the fourth aspect disposed between an anode and a cathode.

In another arrangement, the battery comprises a ceramic electrolyte (e.g., argyrodite Li₆PS₅Cl) disposed between an anode and a cathode, and wherein the battery further comprises an electrolyte of the fourth aspect disposed between the ceramic electrolyte and the cathode and/or anode.

In another arrangement, the battery comprises a cathode of the sixth aspect, wherein a ceramic electrolyte (e.g., argyrodite Li₆PS₅Cl) is disposed between the cathode and an anode, and wherein the cathode comprises an electrically conductive additive (e.g. carbon) and a cathode material (e.g. LiNi_{0.8}Mn_{0.1}Co_{0.1}O₂, known as NMC811), wherein particles of the cathode material are coated with the polymer of the first aspect and/or the electrolyte of the fourth aspect.

The battery may be an alkali metal ion or an alkali metal battery (e.g., Li, Na or K). The battery is suitably a Li-ion or Li-metal battery.

In an eighth aspect, the present invention provides a use of a polymer of the first or third aspect in the manufacture of a battery or a battery component (e.g. an electrolyte or a cathode).

The following numbered statements 1 to 79 are not claims, but instead describe particular aspects and embodiments of the invention:
1. A polymer having a structure according to Formula I:

A-B-A (I)
wherein
A is a polycarbonate block; and
B is a polyether block.
2. The polymer of statement 1, wherein the polyether block B comprises m number of repeating units, wherein m is 5-10,000.
3. The polymer of statement 1, wherein the polyether block B comprises m number of repeating units, wherein m is 15-3000.
4. The polymer of statement 1, 2 or 3, wherein each polycarbonate block A comprises n number of repeating units, wherein each n is 1 to 1000.
5. The polymer of statement 1, 2 or 3, wherein each polycarbonate block A comprises n number of repeating units, wherein each n is 2 to 300.
6. The polymer of any one of the preceding statements, wherein block A has a glass transition temperature (T_{g}) that is ≥20° C. (e.g. 20-120° C.).
7. The polymer of any one of the preceding statements, wherein block A has a glass transition temperature (T_{g}) that is ≥60° C.
8 The polymer of any one of the preceding statements, wherein block A has a glass transition temperature (T_{g}) that is ≥80° C.
9. The polymer of any one of the preceding statements, wherein block A has a glass transition temperature (T_{g}) that is ≥90-115° C.
10. The polymer of any one of the preceding statements, wherein block B has a glass transition temperature (T_{g}) that is ≤20° C. (e.g. −60 to 20° C.).
11. The polymer of any one of the preceding statements, wherein block B has a glass transition temperature (T_{g}) that is ≤0° C.
12. The polymer of any one of the preceding statements, wherein block B has a glass transition temperature (T_{g}) that is ≤−25° C.
13. The polymer of any one of the preceding statements, wherein block B has a glass transition temperature (T_{g}) that is −50 to −30° C.
14. The polymer of any one of statements 1 to 5, wherein block A has a glass transition temperature (T_{g}) that is 90-115° C. and block B has a glass transition temperature (T_{g}) that is −50 to −30° C.
15. The polymer of any one of the preceding statements, wherein block B has a dispersity (Ð) of ≤51.30.
16. The polymer of any one of the preceding statements, wherein a proportion of the A and/or B block repeating units independently comprises a pendant neutral functional group FG_{N} selected from —P(O)(OH)₂, —COOH, —OH, —SO₃H, —NH₂, —C(O)NH₂, —F, —CF₃ and —CN.
17. The polymer of any one of the preceding statements, wherein a proportion of the A and/or B block repeating units independently comprises a pendant anionic functional group FG_{N} selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻.
18. The polymer of any one of the preceding statements, wherein a proportion of the A and/or B block repeating units comprises a neutral functional group being —P(O)(OH)₂.
19. The polymer of any one of the preceding statements, wherein a proportion of the A block repeating units comprises a neutral functional group being —P(O)(OH)₂.
20. The polymer of any one of the preceding statements, wherein block A is amorphous.
21. The polymer of any one of the preceding statements, wherein the polymer has a molecular weight (Mₙ) of 2-150 kg mol⁻¹.
22. The polymer of any one of the preceding statements, wherein the polymer has a molecular weight (Mₙ) of 3-80 kg mol⁻¹.
23. The polymer of any one of the preceding statements, wherein the polymer has a molecular weight (Mₙ) of 10-60 kg mol⁻¹.
24. The polymer of any one of the preceding statements, wherein block B has a molecular weight (Mₙ) of 0.8-150 kg mol⁻¹.
25. The polymer of any one of the preceding statements, wherein block B has a molecular weight (Mₙ) of 3-110 kg mol⁻¹.
26. The polymer of any one of the preceding statements, wherein block B has a molecular weight (Mₙ) of 4-60 kg mol⁻¹.
27. The polymer of any one of the preceding statements, wherein block B has a molecular weight (Mₙ) of 5-45 kg mol⁻¹.
28. The polymer of any one of the preceding statements, wherein block B has a molecular weight (Mₙ) of 6-12 kg mol⁻¹.
29. The polymer of any statements 1 to 27, wherein block B has a molecular weight (Mₙ) of 30-40 kg mol⁻¹.
30. The polymer of any one of the preceding statements, wherein the polymer comprises 10-80 wt % of block A.
31. The polymer of any one of the preceding statements, wherein the polymer comprises 20-75 wt % of block A.
32. The polymer of any one of the preceding statements, wherein the polymer comprises 20
40 wt % of block A.
33. The polymer of any one of statements 1 to 30, wherein the polymer comprises 50-75 wt % of block A.
34. The polymer of any one of statements 1 to 23, wherein block B has a molecular weight (Mₙ) of 30-40 kg mol⁻¹ and the polymer comprises 60-80 wt % (e.g., 65-75 wt %) of block A.
35. The polymer of any one of statements 1 to 23, wherein block B has a molecular weight (Mₙ) of 30-40 kg mol⁻¹ and the polymer comprises 20-40 wt % (e.g., 22-30 wt %) of block A.
36. The polymer of any one of statements 1 to 23, wherein block B has a molecular weight (Mₙ) of 6-12 kg mol⁻¹ and comprises 25-55 wt % (e.g., 32-42 wt %) of block A.
37. The polymer of any one of the preceding statements, wherein block A has a structure according to Formula A-i:

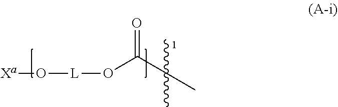

wherein
[symbol] ¹ denotes the point of attachment to B;
X^{a} is an end group; and
L is a linking group separating the two oxygen atoms to which it is attached by a distance of 2-3 carbon atoms.
38. The polymer of statement 37, wherein L is a linking group separating the two oxygen atoms to which it is attached by a distance of 2 carbon atoms.
39. The polymer of statement 37, wherein L is a linking group separating the two oxygen atoms to which it is attached by a distance of 2 carbon atoms, said 2 carbon atoms forming part of a ring.
40. The polymer of statement 39, wherein the ring is a 5- to 7-membered carbocyclyl or heterocyclyl ring.
41. The polymer of statement 40, wherein the ring is a 6-membered carbocyclyl ring.
42. The polymer of any one of the preceding statements, wherein block A has a structure according to Formula A-ii:

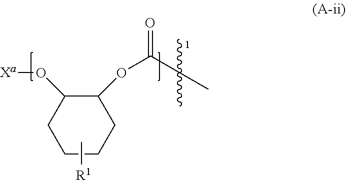

wherein
[symbol] ¹ denotes the point of attachment to block B;
X^{a} is an end group; and
each R¹ is independently absent or a group —X—(R²)ᵥ, in which
each R² is independently a pendant neutral functional group FG_{N} or a pendant anionic functional group FG_{A} as defined hereinbefore;
each v is independently 0 or 1; and
each X is (when v is 1) a linking group (e.g. a divalent group) that links R² to the cyclohexyl ring, or is (when v is 0) a terminal (e.g., monovalent) group.
43. The polymer of statement 42, wherein R¹ is absent, or is

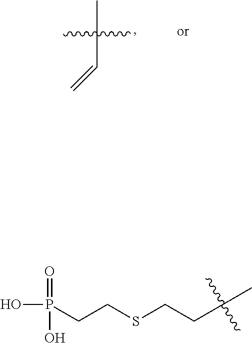

44. The polymer of any one of the preceding statements, wherein the polyether block B comprises a poly(ethylene oxide) backbone.
45. The polymer of statement 44, wherein a proportion of the B block repeating units comprise a side chain independently selected from (1-2C)alkyl, —CH₂OCH₂CH═CH and poly(ethylene oxide) (terminating in an alkyl group).
46. The polymer of any one of the preceding statements, wherein the polyether block B is composed of poly(ethylene oxide), poly(propylene oxide), poly(allyl glycidyl ether) or a copolymer of two or more thereof.
47. The polymer of any one of the preceding statements, wherein the polyether block B is composed of poly(ethylene oxide).
48. The polymer of any one of the preceding statements, wherein the polymer has a structure according to Formula (IA):

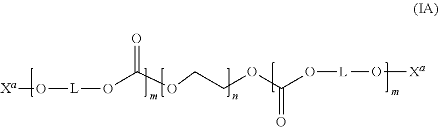

wherein L, X^{a}, m and n are as defined in any one of the preceding statements.
49. The polymer of any one of the preceding statements, wherein the polymer has a structure according to Formula (IB):

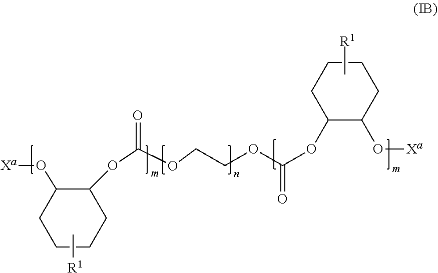

wherein
X^{a}, m and n are as defined in any one of the preceding statements; and
each R¹ is independently absent or a group —X—(R²)ᵥ, in which
each R² is independently a pendant neutral functional group FG_{N} or a pendant anionic functional group FG_{A} as defined hereinbefore;
each v is independently 0 or 1; and
each X is (when v is 1) a linking group that links R² to the cyclohexyl ring, or is (when v is 0) a terminal group.
50. A process for the preparation of a polymer, the process comprising the steps of:
(a) providing a polyether having a hydroxy terminal group at each end; and
(b) growing a polycarbonate on both ends of the polyether by ring-opening copolymerisation of:
(i) an epoxide or an oxetane, and (ii) carbon dioxide.
51. The process of statement 50, wherein the epoxide is 2,3-dimethyl oxirane, a terminal epoxide, a glycidyl ethers or a cyclic epoxide.
52. The process of statement 50, wherein the epoxide is a cyclic epoxide.
53. The process of statement 50, wherein the epoxide is selected from;

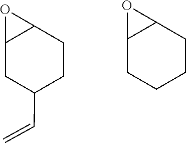

54. The process of any one of statements 50 to 53, further comprising the step of:
(c) modifying a proportion of the polycarbonate and/or polyether repeating units by introducing:
a pendant neutral functional group selected from —P(O)(OH)₂, —COOH, —OH, —SO₃H, —NH₂, —C(O)NH₂, —F, —CF₃ and —CN; and/or
a pendant anionic functional group selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻.
55. The process of statement 54, wherein step (c) comprises modifying a proportion of the polycarbonate and/or polyether repeating units by introducing a pendant neutral functional group being —P(O)(OH)₂.
56. The process of statement 54 or 55, wherein step (c) comprises modifying a proportion of the polycarbonate repeating units.
57. The process of any one of statement 50 to 56, wherein step (b) is conducted in the presence of a catalyst.
58. An electrolyte comprising a mixture of a polymer as defined in any one of statements 1 to 49 and a metal salt.
59. The electrolyte of statement 58, wherein the metal salt is a Na, Li or K salt.
60. The electrolyte of statement 58, wherein the metal salt is of the formula M⁺ X⁻, wherein M⁺ is selected from Na⁺, Li⁺ and K⁺, and X⁻ is selected from BF₄⁻, ClO₄⁻, bis(fluorosulfonyl)imide, bis(trifluoromethanesulfonyl)imide, bis(oxalato)borate, a perfluoroalkylsulfonate (e.g., CF₃SO₃⁻), a polyfluoroalkyl sulfontate, PF₆, AsF₆⁻, cyano(trifluoromethanesulfonyl)imide, bis[(pentafluoroethyl)sulfonyl]imide, B(CN)₄⁻, 4,5-dicarbonitrile-1,2,3-triazole, perylene diimide, 4,5-dicyano-2-(trifluoromethyl)imidazolium and combinations of two or more thereof.
61. The electrolyte of statement 60 wherein M⁺ is Li⁺.
62. The electrolyte of statement 60 or 61, wherein X⁻ is bis(trifluoromethanesulfonyl)imide.
63. The electrolyte of any one of statements 58 to 62, wherein the electrolyte comprises 0.1-80 wt % of the metal salt.
64. The electrolyte of statement 63, wherein the electrolyte comprises 15-70 wt % of the metal salt.
65. The electrolyte of any one of statements 58 to 62, wherein the polymer comprises 60-80 wt % of block A and the electrolyte comprises 15-75 wt % (e.g., 40-75 wt % or 55-70 wt %) of metal salt.
66. The electrolyte of any one of statements 58 to 62, wherein the polymer comprises 20-40 wt % of block A and the electrolyte comprises 15-40 wt % (e.g., 20-35 wt %) of metal salt.
67. The electrolyte of any one of statements 58 to 62, wherein the electrolyte comprises 40
75 wt % (e.g. 55-70 wt %) of metal salt; the polymer comprises 60-80 wt % (e.g., 65-75 wt %) of block A; and block B has a molecular weight (Mₙ) of 30-40 kg mol⁻¹.
68. The electrolyte of any one of statements 58 to 62, wherein the electrolyte comprises 15-40 wt % (e.g. 20-35 wt %) of metal salt; the polymer comprises 20-40 wt % (e.g., 22-30 wt %) of block A; and block B has a molecular weight (Mₙ) of 30-40 kg mol⁻¹.
69. The electrolyte of any one of statements 58 to 62, wherein the electrolyte comprises 15-40 wt % (e.g. 20-35 wt %) of metal salt; the polymer comprises 25-55 wt % (e.g. 32-42 wt %) of block A; and block B has a molecular weight (Mₙ) of 6-12 kg mol⁻¹.
70. A process for making an electrolyte, the process comprising the step of:
(i) preparing a polymer according to the process of any one of statements 50 to 57; and
(ii) mixing the polymer with a metal salt.
71. A cathode for a battery, the cathode comprising a polymer as defined in any one of statements 1 to 49 or an electrolyte as defined in any one of statements 58 to 69.
72. The cathode of statement 71, wherein the cathode is a composite cathode comprising a cathode material (e.g. LiNi_{0.8}Mn_{0.1}Co_{0.1}O₂, known as NMC811), an electrically conductive additive (e.g. carbon) and either or both of a polymer as defined in any one of statements 1 to 49 and an electrolyte as defined in any one of statements 58 to 69.
73. The cathode of statement 72, wherein particles of the cathode material are coated with the polymer and/or the electrolyte.
74. The cathode of statement 72 or 73, wherein the cathode further comprises a ceramic electrolyte (e.g., argyrodite Li₆PS₅Cl).
75. A battery comprising a polymer as defined in any one of statements 1 to 49, an electrolyte as defined in any one of statements 58 to 69, and/or a cathode as defined in any one of statements 71 to 74.
76. The battery of statement 75, wherein the battery comprises an electrolyte as defined in any one of statements 58 to 69 disposed between an anode and a cathode.
77. The battery of statement 75, wherein the battery comprises an electrolyte as defined in any one of statements 58 to 69, said electrolyte being provided as an interlayer located between a ceramic electrolyte (e.g., argyrodite Li₆PS₅Cl) and an anode and/or cathode.
78. The battery of statement 75, wherein the battery comprises a cathode as defined in statement 73, wherein a ceramic electrolyte (e.g., argyrodite Li₆PS₅Cl) is disposed between the cathode and an anode.
79. Use of a polymer as defined in any one of statements 1 to 49 in the manufacture of a battery or a battery component (e.g. an electrolyte or a cathode).

### EXAMPLES

One or more examples of the invention will now be described, for the purpose of illustration only, with reference to the accompanying figures:

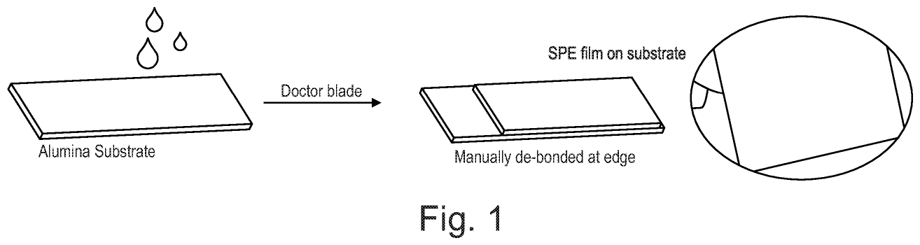

FIG. 1. Procedure used for coating polymer electrolyte on substrate for 180° peel tests.

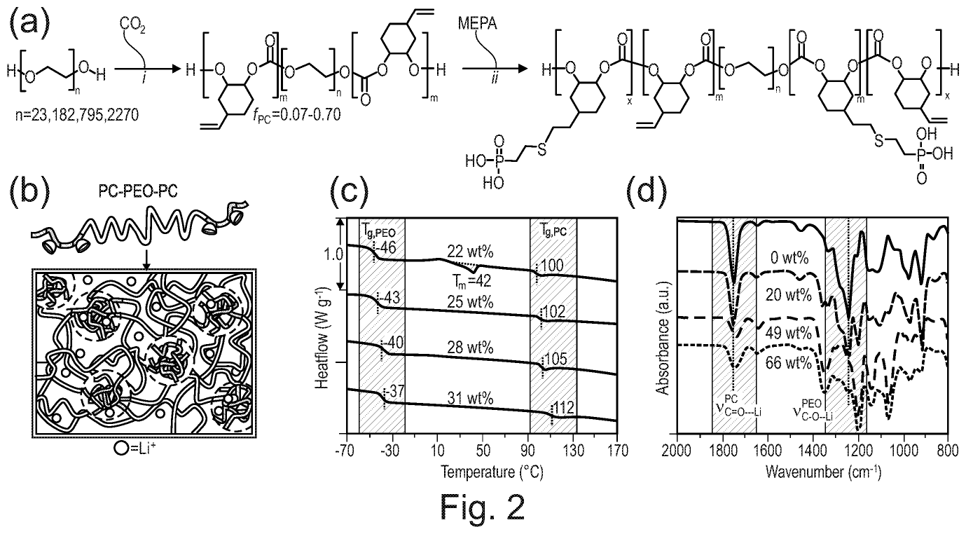

FIG. 2. Synthesis of PC-b-PEO-b-PC SPEs. (a) i CO₂/vCHO ROCOP with PEO macroinitiator (see Table 1 for details). ii UV-mediated thiolene reaction with 2-mercaptoethyl phosphonic acid (MEPA). (b) Schematic of phase-separated PC/PEO blocks with lithium salt (anion not shown). (c) DSC thermograms of CEC(35,0.26) with 22-31 wt % LiTFSI. (d) FTIR of thin films of CEC(35,0.70)/0-66 wt % LiTFSI.

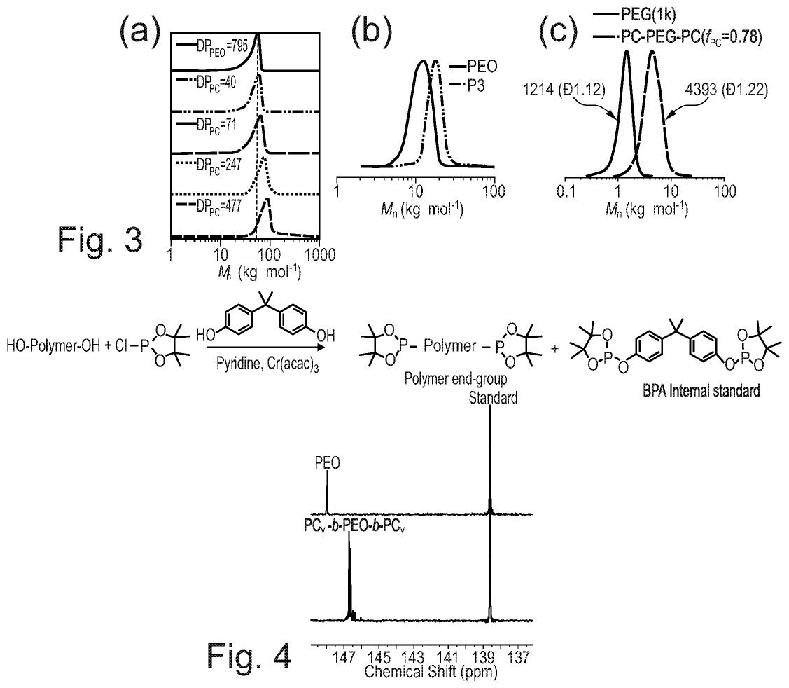

FIG. 3. Size Exclusion Chromatography (SEC) (CHCl₃ eluent, RI detector vs PS standards). (a) 35 kg mol⁻¹ (795 EO units) pure PEO macroinitiator (top) and below different polycarbonate degrees of polymerization (DP_{PC}) corresponding to f_{PC} 0.16-0.70. P1=DP_{PC=71}; P2=DP_{PC=477}. (b) 8 kg mol⁻¹ PEO (182 EO units), f_{PC}=0.37, DP_{PC}=74 (P3). (c) All measured in CHCl₃ eluent, RI detector vs narrow PS standards.

FIG. 4. Polymer end-group analysis by phosphorous test. Stacked ³¹P{¹H}NMR spectra (CDCl₃) of PEO homopolymer (end-group 148 ppm) and CEC (35,0.70) (146.4-146.7 ppm) after reaction of the —OH end groups with phosphorous reagent as shown. The latter is characteristic of PC end-groups, indicating no PEO end-groups remaining in the PC-PEO-PC triblock. The standard at 138.6 ppm is Bisphenol-A. End-group tests were conducted for all triblock polymers to check that only PC end-blocks were present.

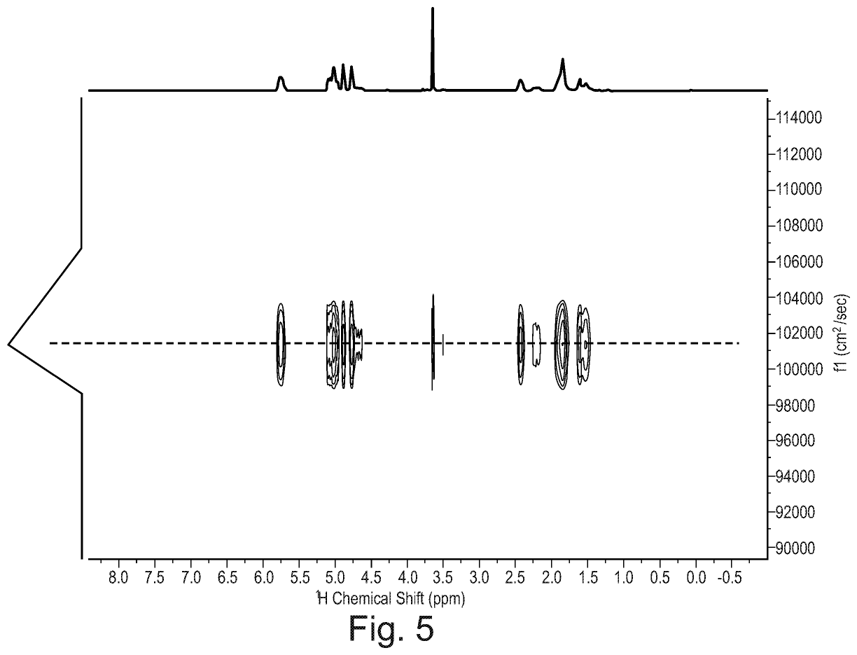

FIG. 5 DOSY NMR for CEC(8,0.51)

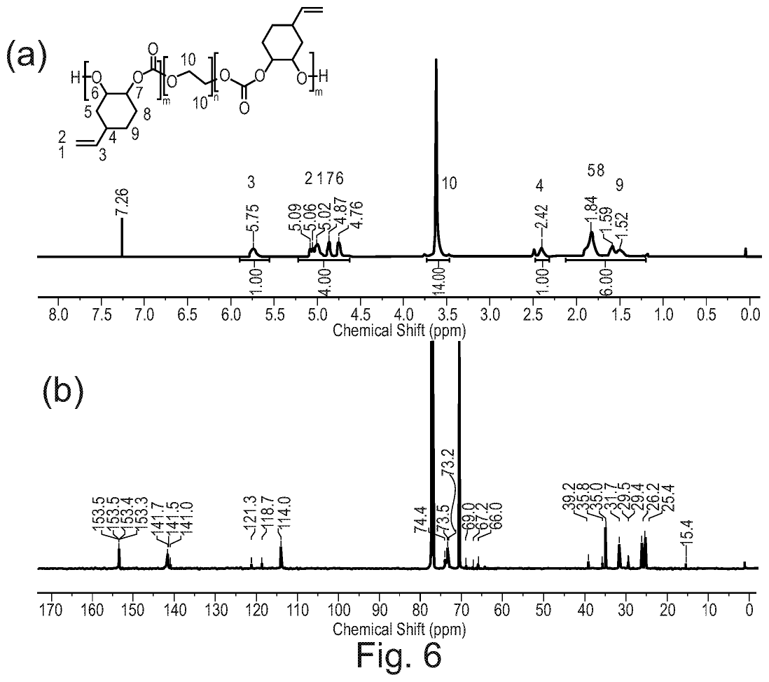

FIG. 6. Representative NMR spectra of purified PC-b-PEO-b-PC. (a) ¹H NMR Spectrum (CDCl₃) for CEC(35,0.55). The wt % PC was determined by relative integration of the vinyl proton (5.75 ppm) or methine (2.42 ppm) vs PEO (3.64 ppm). (b)¹³C{¹H}NMR (CDCl₃) for CEC(35,0.55).

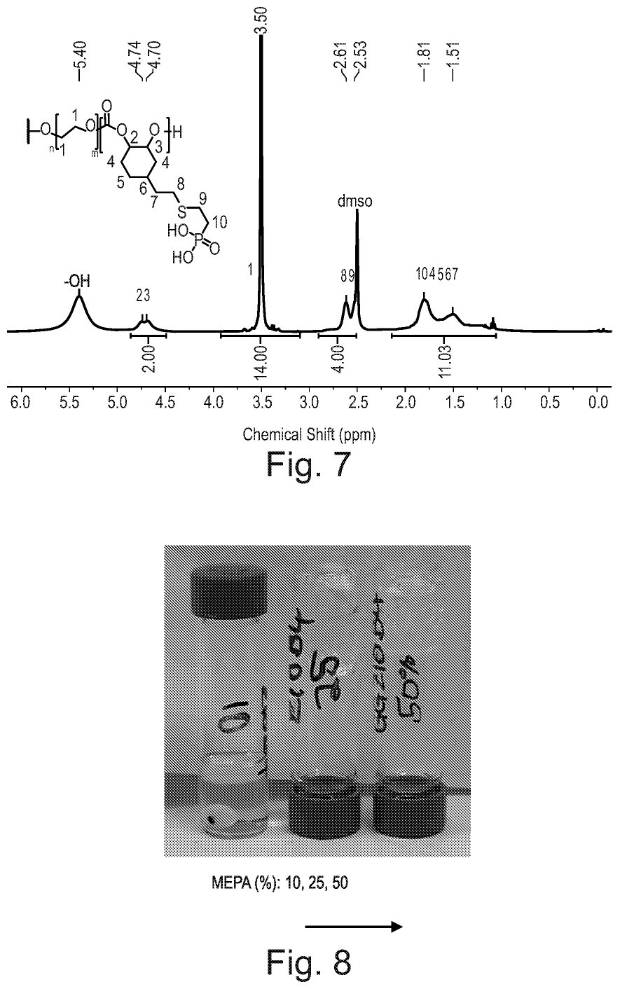

FIG. 7. NMR analysis of MEPA post-functionalized PC-PEO-PC triblock. (a)¹H NMR (dmso-ds) of CEC(35,0.55) with fully functionalized PC block.

FIG. 8. Behaviour observed with higher MEPA content.

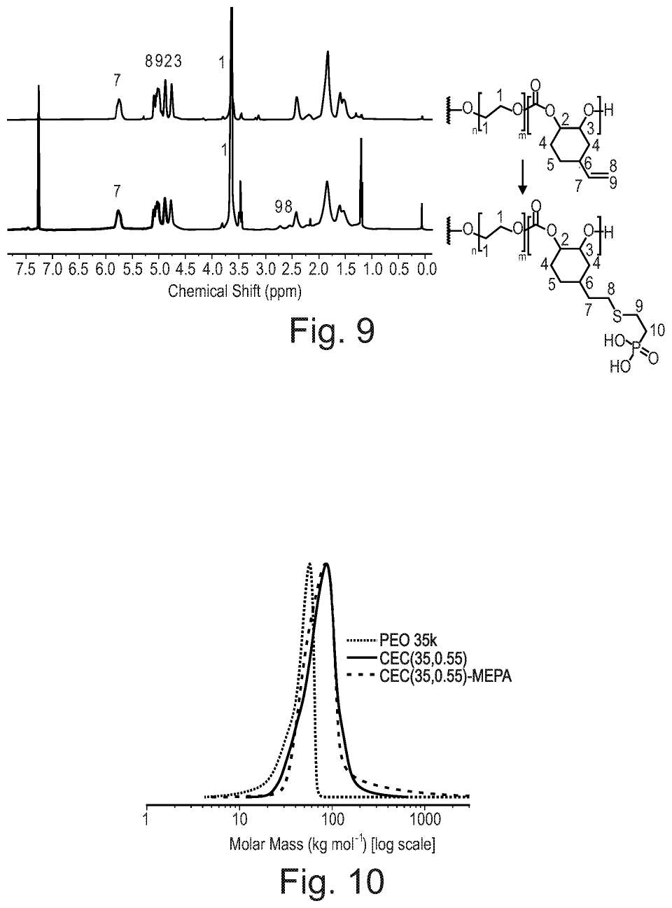

FIG. 9. ¹H NMR spectra (CDCl₃) confirming partial MEPA functionalization of PC. Top: unmodified CEC(35,0.55) and bottom: 6 wt % grafted MEPA (15% PC functionalization).

FIG. 10. SEC (CHCl₃ eluent) of CEC(35,0.55)-g-MEPA (3 wt %) confirming no cross-linking behaviour.

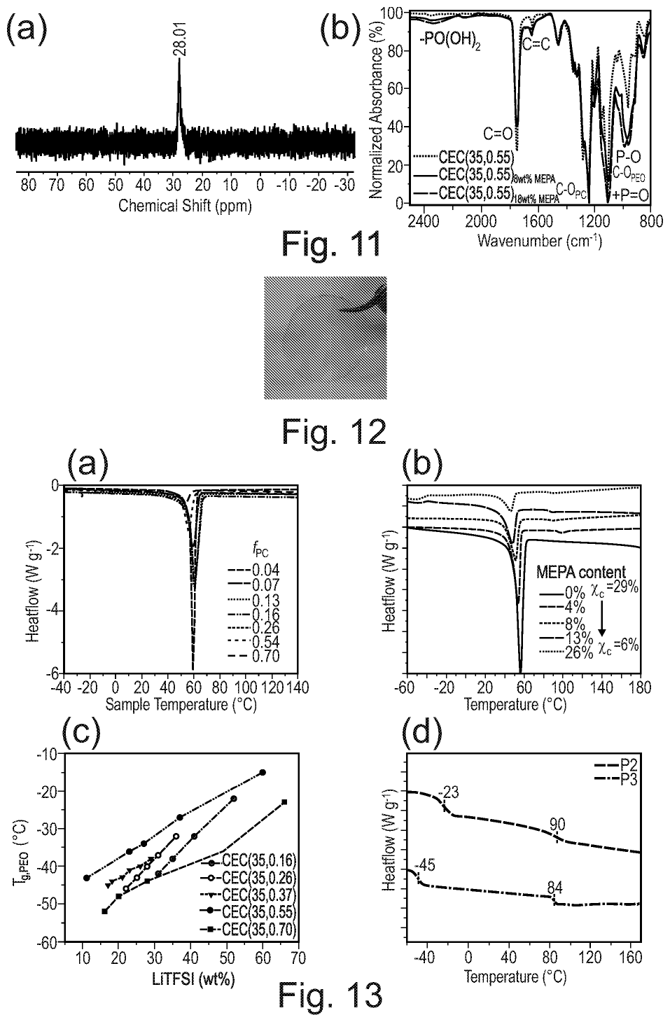

FIG. 11. Additional characterization of partially MEPA decorated polymers. (a)³¹P{¹H}NMR of purified partially post-functionalized triblock polymer. (b) FTIR for CEC(35,0.55).

FIG. 12. Picture of Solid Polymer Electrolyte (SPE) Standalone film

FIG. 13. Additional DSC data for polymers and polymer electrolytes. (a) Influence of f_{PC} on PEO crystallinity (χ_{c}) for M_{n,PEO}=35 kg mol⁻¹ with no added lithium salt. PEO crystallinity was calculated using ΔH_{f}=214.6 J g⁻¹ for 100% crystalline PEO. (b) Influence of grafted MEPA wt % on thermal properties for CEC(35,0.55). (c) T_{g, PEO} as a function of lithium salt content for triblock polymers with M_{n,PEO}=35 kg mol⁻¹ and f_{PC} as labelled. (d) DSC traces for lead polymers, P2 and P3 at optimized salt contents.

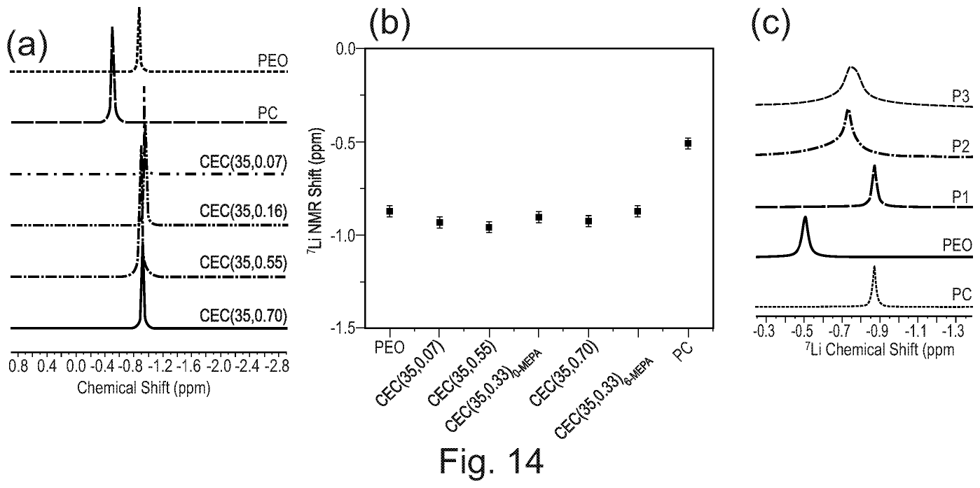

FIG. 14. Solution-state ⁷Li NMR of Polymer Electrolytes. (a) ⁷Li NMR spectra (CDCl₃) of PEO and PC homopolymers/20 wt % LiTFSI (top) and triblock polymers (bottom) with 7-70 wt % PC and PEO Mₙ=35 kg mol⁻¹/20 wt % LiTFSI. (b) Plot of ⁷Li NMR shift for different polymers/20 wt % LiTFSI. (c) ⁷Li NMR of lead polymer samples.

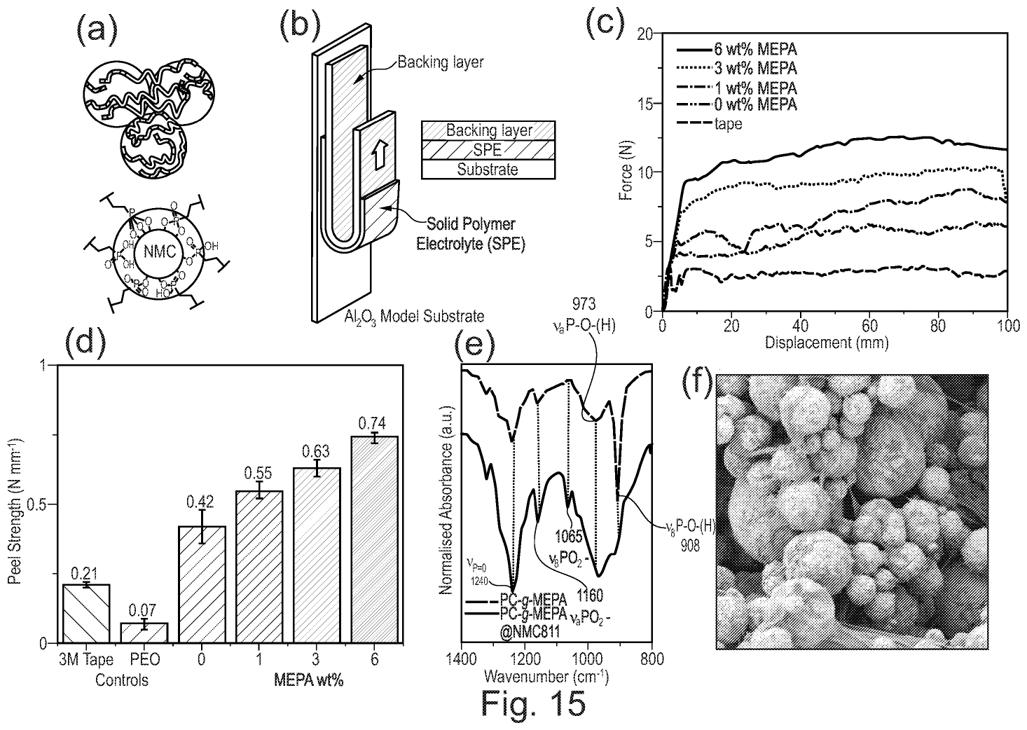

FIG. 15. Adhesive Properties of PC-b-PEO-b-PC Solid Electrolytes. (a) Schematic of polymer binding and phosphonic acid binding modes. (b) Schematic of 180° Peel Test. (c) Force vs displacement for CEC(35,0.37) with 0-6 wt % grafted MEPA. (d) Corresponding peel Strength. (e) FTIR in region of P—O stretching absorptions. (f) SEM of NMC811 with 3 wt % CEC(35,0.37)-g-6MEPA.

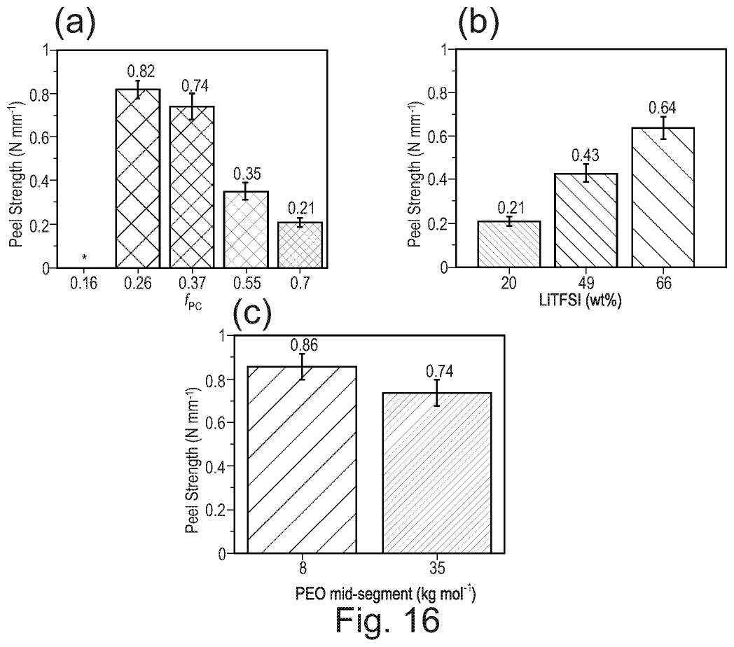

FIG. 16. Additional 180° Peel tests on Alumina. (a) CEC(35, f_{PC}), 6 wt % MEPA, r=13. (b) CEC(35, 0.70) with different wt % LiTFSI and (c) CEC(M_{n,PEO}, 0.37). *=tacky film.

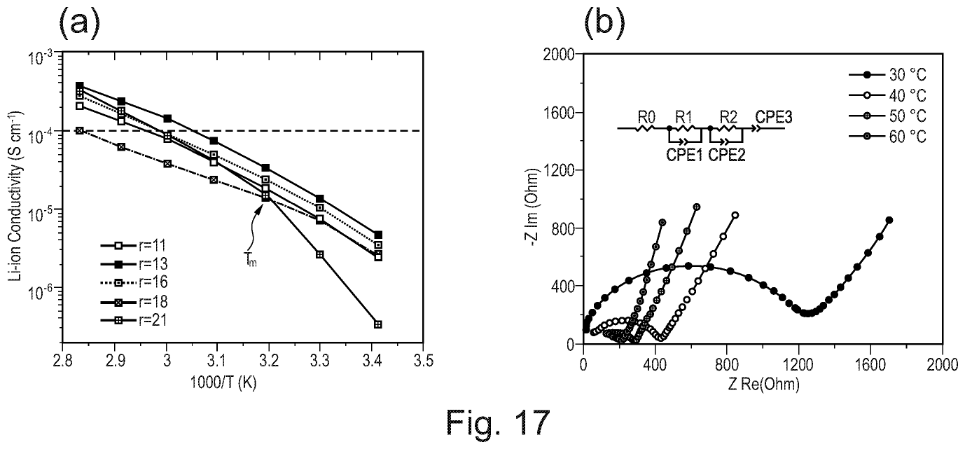

FIG. 17. Optimisation of LiTFSI content for CEC(35,0.37). (a) Li-ion conductivity as a function with gold blocking electrodes: Au|SPE|Au (r=13 corresponds to 28 wt % LiTFSI). b) Representative Nyquist curves.

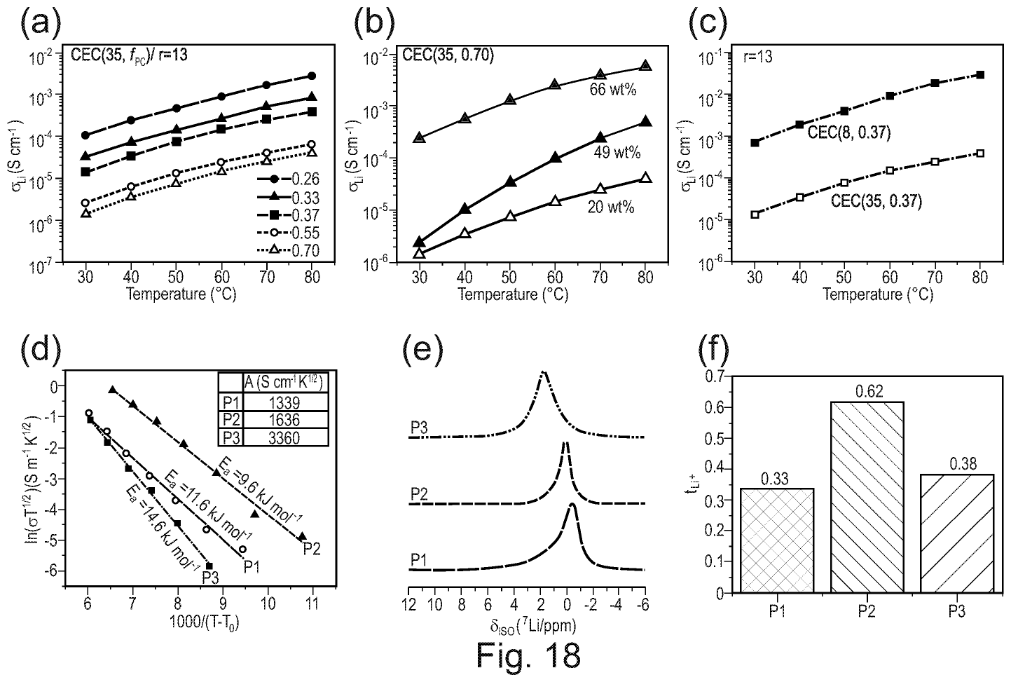

FIG. 18. Li-ion Conductivity of PC-b-PEO-b-PC Solid Electrolytes. (a) CEC(35, f_{PC})/LiTFSI. (b) CEC(35,0.70) with 20, 49 and 66 wt % LiTFSI (c) PEO MW CEC(M_{PEO},0.37) where M_{PEO}=8 or 35 kg mol⁻¹. (d) VTF plots for P1=CEC(35,0.26)/28, P2=CEC(35, 0.70)/66 and P3=CEC(8,0.36)/26 wt % LiTFSI. (e) Solid-state ⁷Li NMR. (f) Lithium transference numbers (t_{Li+}) from PFG NMR.

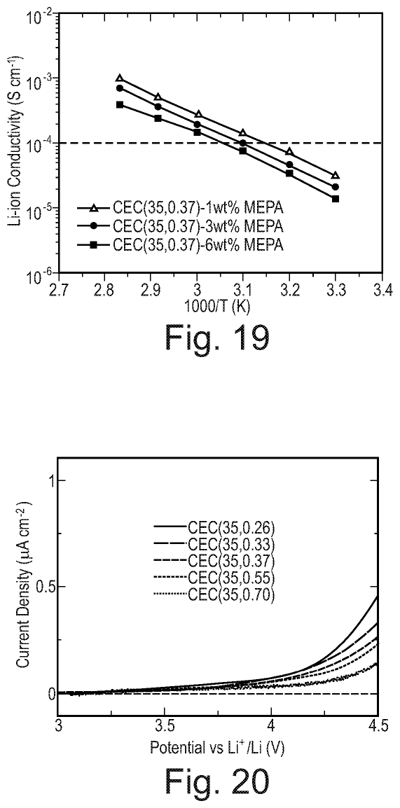

FIG. 19. Li-Ion conductivity as function of MEPA wt %.

FIG. 20. Oxidative stability. Cell set-up: Li|SPE|SS (SS=stainless steel)

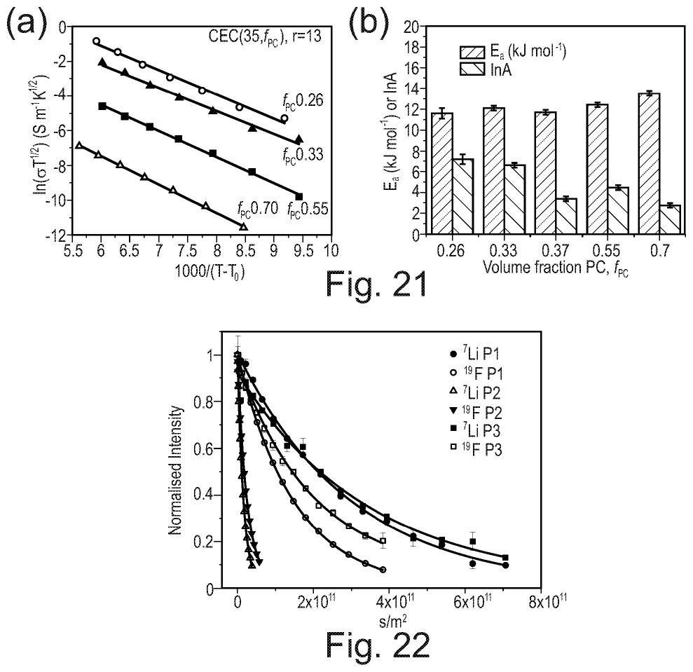

FIG. 21. Additional VTF Plots. (a) VTF plots for CEC(35, f_{PC}). (b) Eₐ, InA from VTF plots.

FIG. 22. Diffusion PFG Decays.

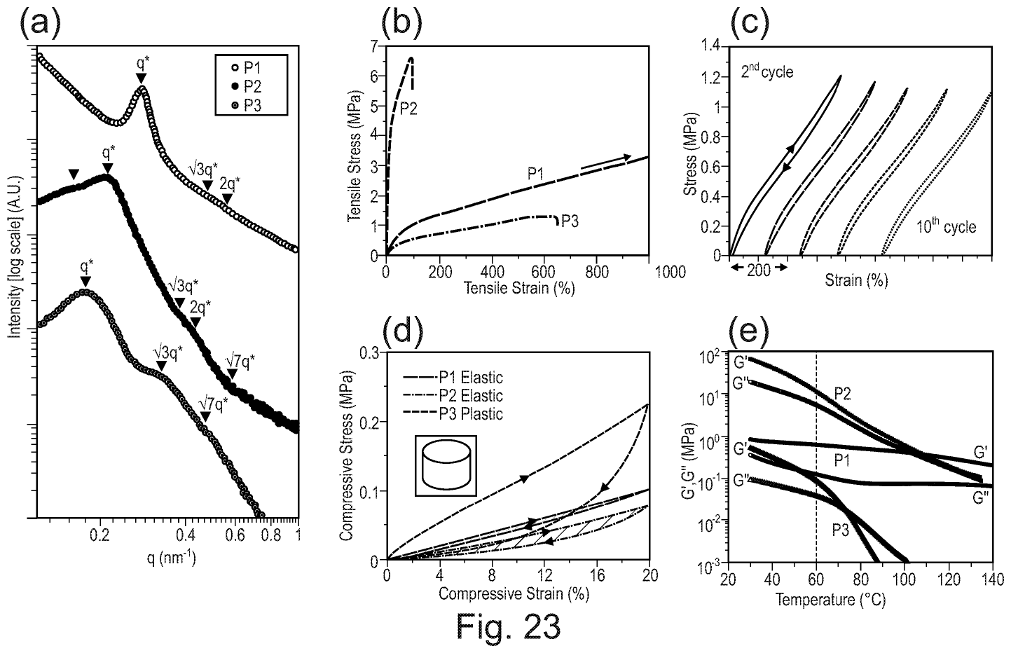

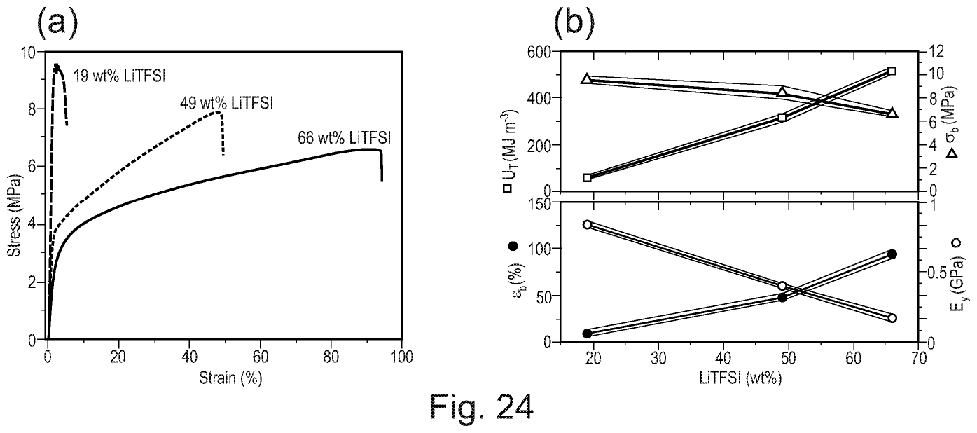

FIG. 23. Mechanical Properties of PC-b-PEO-b-PC Solid Electrolytes. (a) SAXS profiles (b) Tensile stress-strain curves for P1-P3 (10 mm min⁻¹ strain rate). (c) Cyclic tensile testing of P1 to 200% strain. (d) Tensile compressive properties. (e) G′, G″ 30 to 140° C., 2° C. min⁻¹, ω=1 Hz.

FIG. 24. Toughening of CEC(35,0.70) on salt addition. (a) Representative Stress-strain curves (10 mm min⁻¹ strain rate, measured under tension). (b) Plots of tensile toughness, elongation at break, tensile strength and Young's Modulus as a function of salt content.

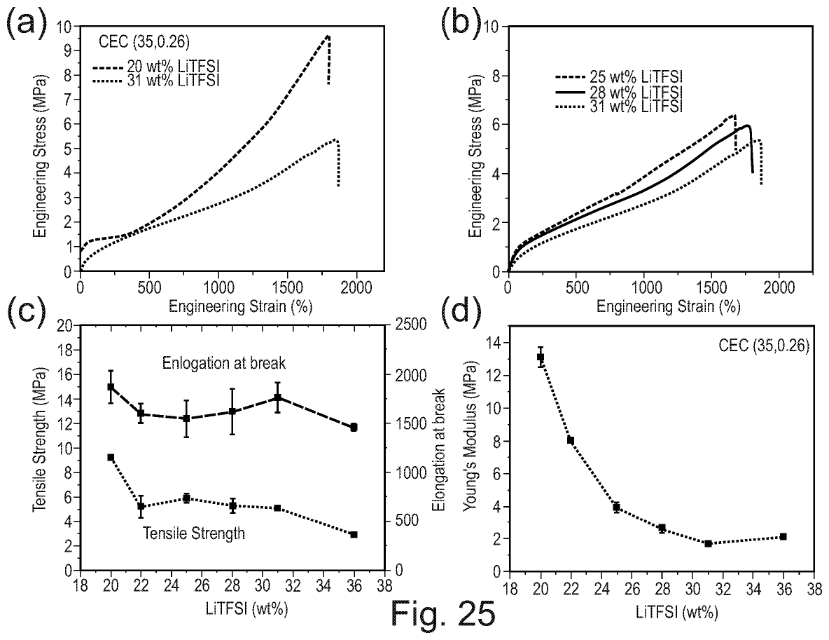

FIG. 25. Additional stress-strain curves for CEC(35,0.26). (a) 20 and 31 wt % LiTFSI. (b) 25, 28, 31 wt % LiTFSI. (c) Tensile strength and elongation at break as a function of LiTFSI. (d) Young's Modulus as a function of LiTFSI.

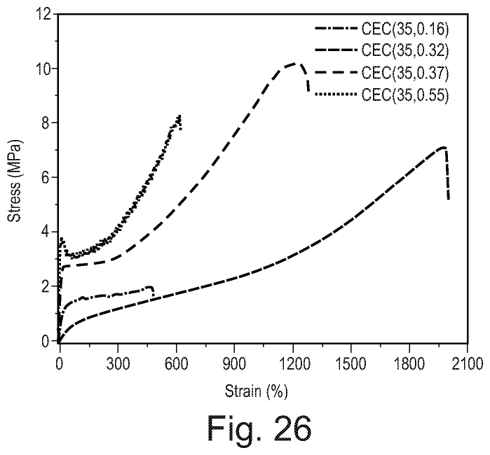

FIG. 26 Mechanical properties as a function of PC content. Representative tensile stress-stain curves for CEC(35, f_{PC}), r=13.

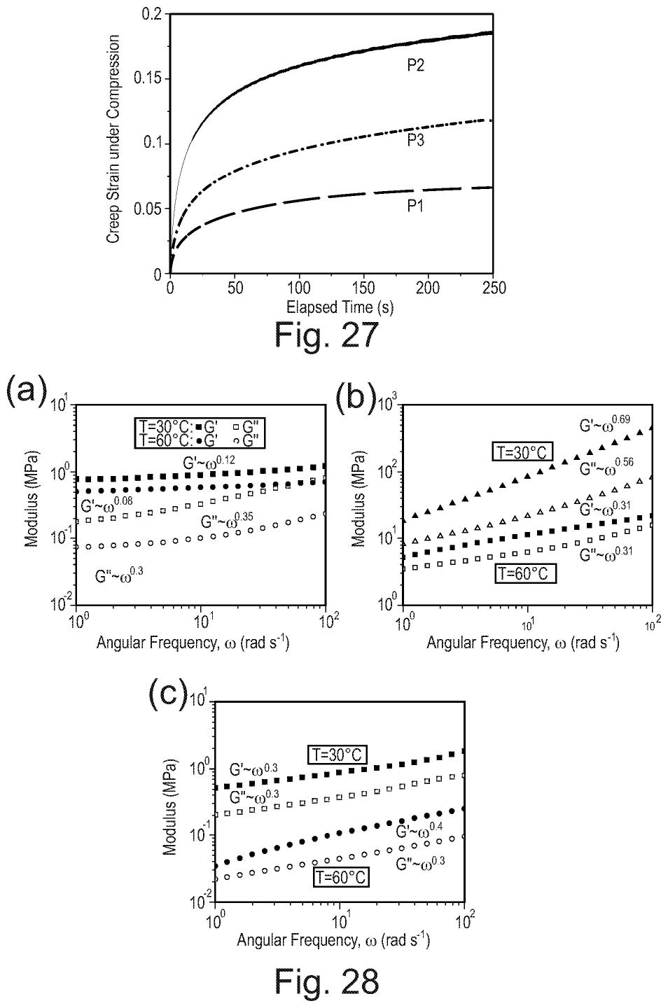

FIG. 27. Creep Experiments at RT under compressive stress.

FIG. 28. Storage and loss moduli (G′, G″) as a function of frequency at T=30 and 60° C. (a) P1. (b) P2. (c) P3. All measurements conducted at 1% amplitude strain in the linear viscoelastic region.

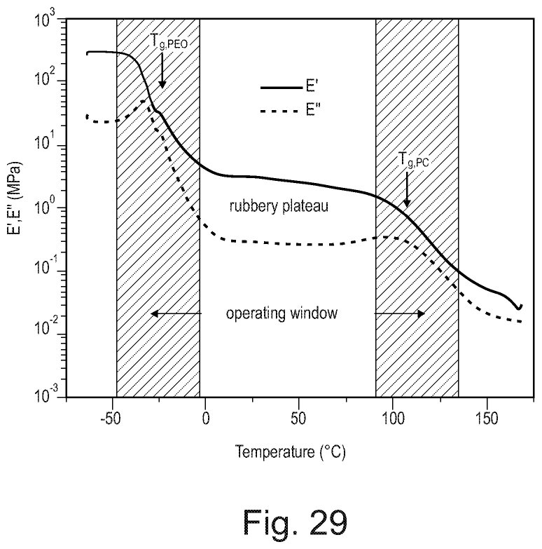

FIG. 29. Dynamic mechanical thermal analysis (DMTA) of P1.

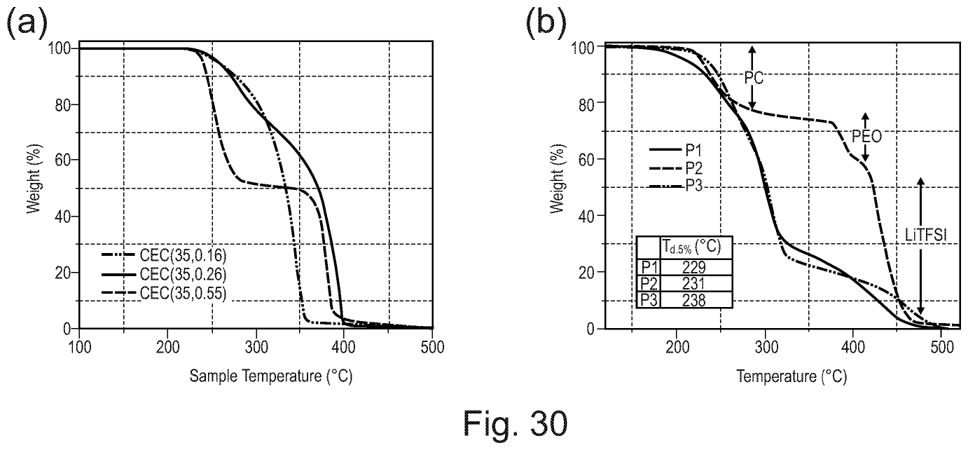

FIG. 30. TGA curves. (a) CEC(35,f_{PC}) series. (b) Polymer electrolytes P1, P2 and P3.

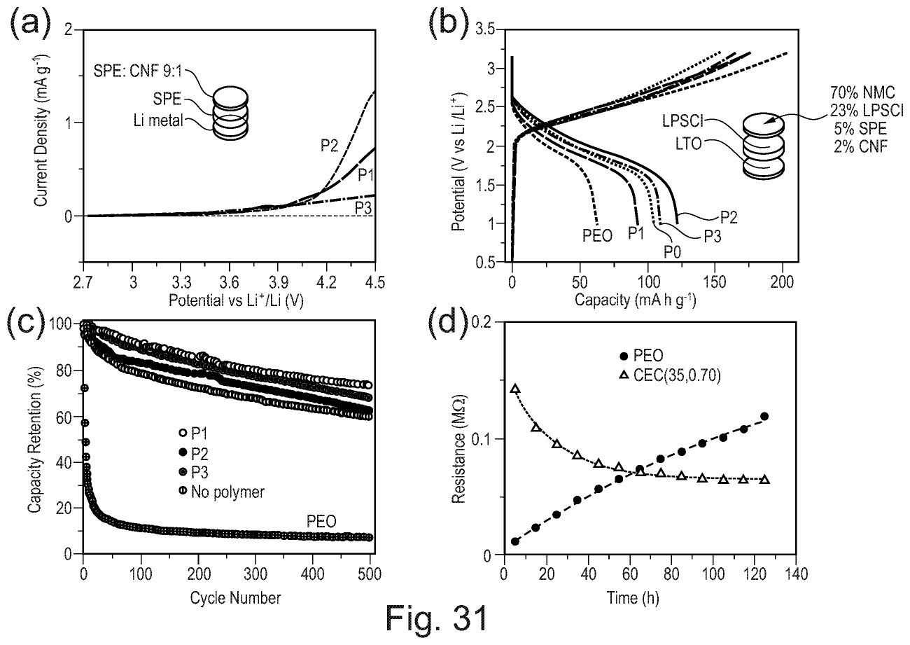

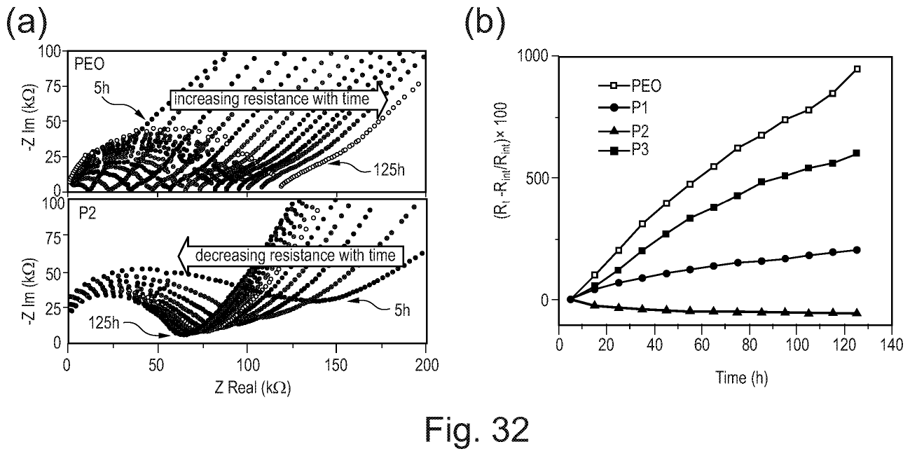

FIG. 31. Evaluation of Cell Performance (a) Oxidative stability by linear sweep voltammetry from the open circuit voltage to 6 V at 0.1 mV s⁻¹, 60° C. and 10 MPa applied pressure. (b) First charge-discharge capacity, 0.5 C, 60° C., 1 MPa applied stack pressure (see ESI for further detail). (c) Cycling performance: Capacity retention vs cycle number. (d). Stability vs. argyrodite LPSCI,

FIG. 32. Stability vs LPSCI. (a) Nyquist curves at RT for SPE|LPSCI|SPE held at 60° C. for defined time periods. (b) Change in interfacial resistance with time. The change in resistance (Rₜ−Rᵢₙₜ) where Rₜ=resistance at time, t and Rᵢₙₜ is the initial resistance is expressed as a percentage of Rᵢₙₜ.

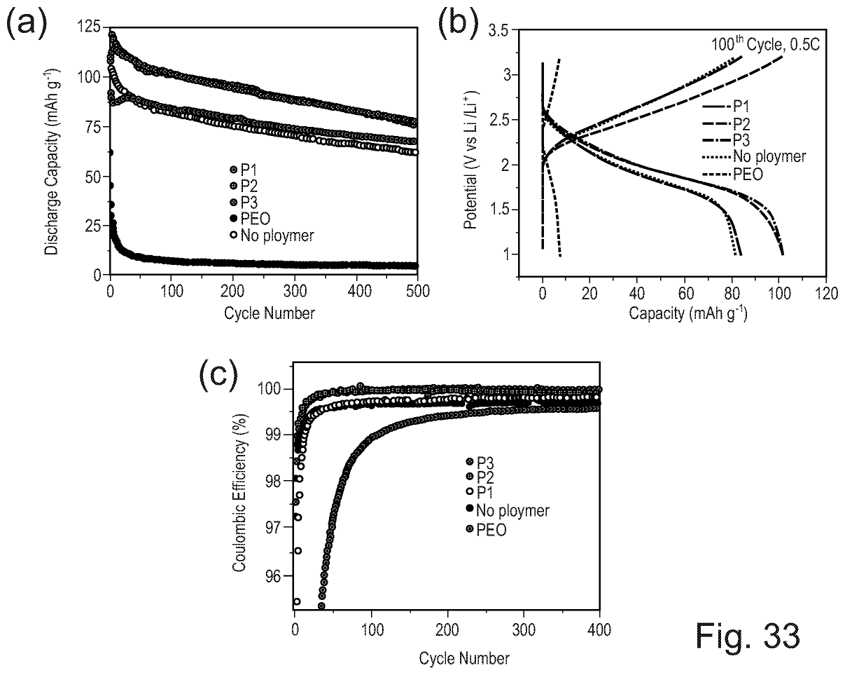

FIG. 33. Additional Cell Performance Data. (a) Discharge Capacity vs cycle number for LTO|LPSCI|NMC-SPE composite at 60° C., 0.5 C. (b) Charge-Discharge voltage profiles at 100^{th} cycle. (c) Coulombic Efficiency vs cycle number.

### MATERIALS AND METHODS

Materials: 4-vinyl cyclohexene oxide, vCHO purchased from ACROS and purified by drying over CaH₂ and fractional distillation. Poly(ethylene oxide) (PEO) was purchased from Sigma Aldrich and dried under vacuum at 110° C. for 24 h prior to use. Anhydrous diethyl carbonate (DEC) was purchased from Sigma Aldrich, degassed by freeze-pump thaw (3 cycles) before being stored over 3 Å molecular sieves under nitrogen. Lithium bis(trifluoromethanesulfonyl)imide (LiTFSI) was purchased from Sigma Aldrich and dried under vacuum at 110° C. for 48 h before being stored in a glovebox. Lithium bis(fluorosulfonyl)imide (LiFSI) was purchased from Solvionic and stored in a glovebox prior to use. CP Grade (BOC, 99.995%) CO₂ was used for all polymerizations and dried through two VICI purifier columns. Anhydrous THF for polymer electrolyte film formation was obtained from Solvent Purification System (SPS), degassed by freeze-pump thaw (3 cycles) and stored in a glovebox over 3 Å molecular sieves. All other reagents were purchased from Sigma Aldrich and used as received.

NMR: ¹H, ³¹P {¹H} and ¹³C{¹H}NMR were recorded on a BrukerAvance Ill HD 400 MHz spectrometer. DOSY spectra were recorded on Bruker Avance Ill HD 500 MHz spectrometer.

Size Exclusion Chromatography (SEC): Polymer (2-10 mg) dissolved in HPLC grade CHCl₃ (1 mL) was syringe filtered through 2 μm filters before being injected into an Agilent PL GPC-50 instrument, with two PSS SDV 5 μm linear M columns heated to 30° C. HPLC grade CHCl₃ was used as the eluent at a flow rate of 1.0 mL min⁻¹ with RI detection calibrated using a series of narrow molecular weight polystyrene standards. Agilent SEC post-run program was used to analyze the data.

Differential Scanning Calorimetry (DSC): These were recorded for purified polymer samples and solid polymer electrolyte films on a Mettler Toledo DSC3 Star calorimeter under a nitrogen flow (80 mL min⁻¹). Samples were heated to 200° C. and held for 5 minutes to remove any thermal history before heating and cooling from −80 to 200° C. at a rate of 10° C. min⁻¹. Glass transition temperatures (T_{g}) were determined from the midpoint of the transition in the second heating curve.

Thermoqravimetric Analysis (TGA): Measured on Mettler-Toledo Ltd TGA/DSC 1 system. Powder polymer samples were heated from 30 to 500° C. at a rate of 5° C. min⁻¹, under N₂ flow (100 mL min⁻¹).

Phosphorus end group tests: Following a literature procedure²², to polymer (40 mg) dissolved in CDCl₃ (0.4 mL) was added 40 μL of solution containing Cr(acac)₃ (5.5 mg) and internal standard, bisphenol A (400 mg) in pyridine (10 mL) followed by 40 μL of 2-chloro-4,4,5,5-tetramethyl dioxaphospholane.

Rheology: Shear storage (G′) and loss moduli (G″) were measured on a TA instruments Q800 with 25 mm stainless steel platens. Measurements were conducted in the linear viscoelastic region as determined by an amplitude sweep conducted at 30 and 200° C. The polymer electrolyte was heated from 30 to 200° C. at 2° C. min⁻¹, 1 Hz frequency, 0.1% amplitude strain. Frequency sweeps were also conducted between 3° and 100° C. at 10° C. intervals.

Dynamic Mechanical Thermal Analysis (DMTA): Storage (E′) and loss moduli (E″) were measured on a TA instruments Q850 in tension mode at 0.1% strain, 1 Hz frequency from −60 to +180° C. at a heating rate of 3° C. min⁻¹.

ATR-FTIR: IR spectra of thin films were recorded on a Perkin Elmer Spectrum 100 (FT-IR) with an AT-IR crystal or a Varian FT-IR 3100 spectrophotometer (Golden Gate). All the IR measurements were performed in the reflection mode at a resolution of 4 cm⁻¹.

Tensile Testing: Dumbbell specimens were cut from polymer electrolyte films according to ISO 527-2, specimen type 5B with Zwick ZCP020 cutting press (length=35 mm, gauge length=10 mm, width=2 mm). Monotonic uniaxial extension experiments were carried out on a Shimadzu EZ-LZ Universal testing instrument at an extension rate of 10 mm min⁻¹. An external camera was used to calculate the Young's Modulus, E_{y} within the 0.025-0.25% strain region. 10 Specimens were tested for each material. Cyclic tensile tests were conducted to 20 or 200% strain at a rate of 10 mm min⁻¹. 10 Cycles were measured for each specimen, 3 specimens for each sample.

Compression Testing: Polymer electrolytes were pressed into pellets (10 mm diameter, 2 cm thick) using a Carver Hotpress at 80° C. and a 10 mm diameter die set. Clear, colourless pellets were inspected to ensure they were free from air bubbles prior to testing. Compression experiments were carried out on a Shimadzu EZ-LZ Universal testing instrument fit with compression jigs at a rate of 10 mm min⁻¹.

180° Peel Tests: Solid polymer electrolyte (0.4 g) in THF (4 ml) was cast using a doctor blade (80 μm wet film thickness) onto alumina sheets (20×80 mm), and the solvent was allowed to evaporate at RT (FIG. 1). The coated alumina sheets were then dried in a vacuum oven for 72 h before testing. 3M® scotch tape was applied to the polymer electrolyte coated alumina. A corner of the coating was manually de-bonded from the alumina substrate, and a Shimadzu EZ-LZ universal tensile tester was used to peel the coating off at a 180° angle and rate of 305 mm/min. The force required to remove the coating was measured. Peel strength (N mm⁻¹)=Peel force/width.

Electrochemical Impedance Spectroscopy (EIS): Discs of polymer electrolyte films were cut using a cutting press (16 or 18 mm diameter). The SPE discs were then sandwiched between two gold block electrodes (Au|SPE|Au) and placed inside a CESH cell. Impedance measurements were conducted between 1 Hz and 0.1 MHz using Biologic Impedance Analyzer over 30 to 80° C. with 0.5 h soak time at each temperature. The resulting Nyquist curves were analyzed using EC-labs software to fit an equivalence circuit and determine resistance, R. Conductivity (σ) was then determined as: σ=//AR, where A=the polymer electrolyte disc area and/the electrolyte thickness (0.1-0.45 mm, see Table S4).

Linear Sweep Voltammetry (LSV): These were recorded for CEC(35, f_{PC}) prepared as polymer electrolyte discs (as described in EIS measurements above). Measurements were recorded at RT vs Lithium foil in a PEEK cell with stainless steel (SS) counter-electrode (Li|SPE|SS). The open-circuit voltage (OCV) was first recorded for 12 hours to ensure stability before conducting experiments at 1 mV s⁻¹ from the OCV to 5 V. For lead polymers P1-P3, LSV was also measured vs lithium metal with a polymer-carbon nanofibre composite counter electrode at 60° C. and 0.1 mV s⁻¹ from the OCV to 6 V.

Small Angle X-ray Scattering (SAXS): Polymer films were submitted to Harwell Diamond Light Source in a solid sample grid for SAXS analysis (DL-SAXS, P38 instrument). Scans (3×5 min) were conducted at camera lengths of 4.5 and 1 m, beam energy=9.2 keV (using the Ga MetalJet). SAXS curves reported are an average of the 3 scans measured from data collected at 1 m. Samples were not annealed prior to testing to reflect experimental conditions of tensile testing.

### Experimental

General polymerisation procedure: Taking CEC(35, 0.26) as an example (for notation see Table 1), PEO with Mₙ=35 kg mol⁻¹ (9.3 g, 0.27 mmol, 20 equiv.) was dried under vacuum at 110° C. for 24 h. At room temperature in an inert atmosphere, vCHO (10 ml, 80 mmol, 6000 equiv.) and LMgCo(OAc)₂ (10 mg, 0.013 mmol, 1 equiv.) were added. DEC (20 ml) was then added to the reaction mixture, and any remaining catalyst residue was rinsed into the solution. The nitrogen headspace was then replaced with CO₂ by 3 vacuum-CO₂ cycles before placing the solution in a pre-heated oil bath to 100° C. Aliquots were taken from the reaction mixture at various time points under a stream of CO₂ gas and analyzed by ¹H NMR spectroscopy to monitor the conversion of vCHO monomer (3.1-3.2 ppm) to polycarbonate (4.76 ppm). For CEC(35, 0.26), after 6 hours, the reaction was cooled to room temperature and quenched by adding benzoic acid (˜16 mg, 0.13 mmol, 10 equiv.) dissolved in the minimum amount of dichloromethane. The polymer was isolated by precipitation on pouring the solution into a large excess of diethyl ether or methanol (˜400 ml) and vacuum filtration. The polymer was further purified by rinsing the filtrate with ether/methanol and toluene to obtain a pure white powder (12.5 g, 90%). NB. for f_{PC}>0.5, methanol should be used as the antisolvent and the product not rinsed with toluene; for M_{n,PEO}≤8 kg mol⁻¹, hexane should be used to precipitate the polymer.

General procedure for thiolene reaction: To CEC(35, 0.26) (1 g, 1.6 mmol C═C, 1 equiv. C═C) dissolved in degassed THF (10 ml), MEPA (66 mg, 0.46 mmol, 0.3 equiv.) followed by DMPA (12 mg, 0.046 mmol, 0.03 equiv.) was added. NB. for polymers with f_{PC}<0.3, gentle heating is required to disrupt PEO crystallinity and dissolve the block polymer in THF. The solution was then exposed to UV light for 0.5 h with stirring before precipitating into diethyl ether. The polymer was isolated as a white powder/material and washed twice with diethyl ether (˜1 g).

Synthesis of LMgCo(OAc)₂ catalyst: The macrocycle ligand, HL2 was synthesized as per previous literature reports. The Mg(II)Co(II) heterodinuclear complex was synthesized as previously reported:²³

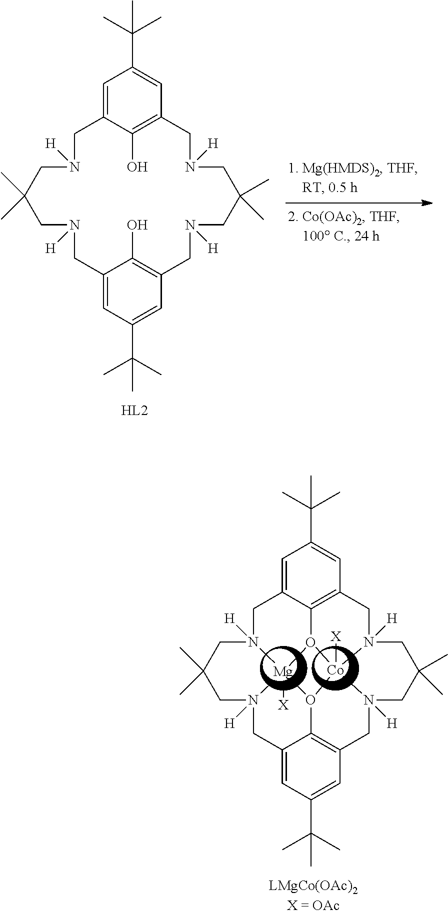

### Results

### Polymer Electrolyte Synthesis

Triblock polymers were synthesized using commercial PEO (α,ω-hydroxyl end terminated) as a bifunctional macro-initiator. Readily available and narrow disperse PEO with molar masses ranging from 1-100 kg mol⁻¹ (23-2272 EO repeat units) were considered. Chain extension of the polyether mid-segment with polycarbonate (PC) end-blocks was achieved by the controlled ring-opening copolymerization (ROCOP) of CO₂ with vCHO, catalyzed by heterodinuclear complex LMgCo(OAc)₂ (FIG. 2a). ROCOP can be initiated directly from the hydroxyl end-groups of PEO, unlike the modification of PEO with PS end-blocks, which requires additional chain-end modification. The catalyst shows high activity for CHO/CO₂ ROCOP (TOF=455-1205 h⁻¹ at 80-120° C.) and excellent selectivity for polycarbonate (i.e. perfectly alternating CO₂/epoxide enchainment) over polyether or cyclic carbonate formation. Polymerizations were conducted at 1 bar CO₂ pressure on a 10-15 g scale in neat epoxide or with M_{n,PEO}>8 kg mol⁻¹, diluted in diethyl carbonate (DEC) to improve macro-initiation/chain transfer efficiency from PEO end-groups by overcoming viscosity limitations. A ratio of 1:20 catalyst: PEO —OH end-groups was used. The hygroscopic PEO macro-initiators were dried under vacuum at 100° C. for 24 h before use to avoid advantageous water, acting as a chain initiator.

Conversion of vCHO monomer to polycarbonate was determined by ¹H NMR analysis of the crude reaction mixture. The resulting triblock polymers, PC-b-PEO-b-PC, were isolated as white powders in high yield (85-90%) by precipitation from diethyl ether.

Size-elusion chromatography (SEC) of the purified copolymers confirmed an increase in molecular mass (Mₙ) on PEO chain extension with PC whilst maintaining narrow dispersity (D 1.13-1.23), supporting block formation over mixtures of unconnected PEO and PC homopolymers (FIG. 3). End-group titration provided additional evidence showing only PC end-units and no residual uninitiated PEO (FIG. 4). DOSY NMR indicated a single diffusion coefficient for the triblock rather than multiple for a mixture (FIG. 5). The wt % PC in the purified polymers was determined by ¹H NMR analysis (FIG. 6) and varied by changing the PEO loadings and reaction times (Table 1). Polymers with different PEO mid-segment lengths and varying volume fractions of PC (f_{PC}) were synthesized to tailor the mechanical properties and ionic conductivity.

TABLE 1
Synthesis of PC-b-PEO-b-PC Triblock Polymers.^{a}

| | | | | | vCHO | | | | |
|---|---|---|---|---|---|---|---|---|---|
| | wt % | [Cat]:[PEO]/\| | [Cat] | Cat | conv. | T | Triblock Mₙ (kg mo^{l-1})^{g} | | |
| Polymer^{b} | PC^{c} | [vCHO] | mM | mol %^{d} | (%)^{e} | (h)^{f} | Theory | SEC [ [symbol] ]^{e} | NMR |
| CEC(35, 0.07) | 7 | 1:20:600 | 0.44 | 0.2 | 45 | 0.5 | 37 | 33.9 [1.09] | 37.6 |
| CEC(35, 0.16) | 16 | 1:20:6000 | 0.44 | 0.02 | 11 | 2 | 41 | 40.9 [1.11] | 41.7 |
| CEC(35, 0.26) | 26 | 1:20:6000 | 0.44 | 0.02 | 34 | 6 | 52 | 43.5 [1.13] | 47.0 |
| CEC(35, 0.33) | 32 | 1:20:6000 | 0.44 | 0.02 | 41 | 7 | 56 | 49.0 [1.11] | 51.5 |
| CEC(35, 0.37) | 36 | 1:20:6000 | 0.44 | 0.02 | 50 | 8 | 60 | 50.6 [1.16] | 55.0 |
| CEC(35, 0.55)* | 54 | 1:20:6000 | 0.44 | 0.02 | 96 | 12 | 83 | 67.3 [1.21] | 76.5 |
| CEC(35, 0.70) | 70 | 1:20:12000 | 0.22 | 0.01 | 82 | 24 | 119 | 92.1 [1.23] | 115 |
| CEC(8, 0.37) | 37 | 1:20:2400 | 3.2 | 0.04 | 30 | 3 | 14 | 12.7 [1.06] | 12.5 |
| CEC(8, 0.51) | 51 | 1:20:2400 | 3.2 | 0.04 | 50 | 5 | 18 | 17.0 [1.08] | 16.0 |
| CEC(8, 0.70) | 70 | 1:20:2400 | 3.2 | 0.04 | 74 | 7 | 23 | 20.4 [1.07] | 27.0 |
| CEC(3.4, 0.11) | 9 | 1:20:1000 | 8 | 0.1 | 6 | 0.2 | 4 | 4.9 [1.08] | 4 |
| CEC(3.4, 0.43) | 41 | 1:20:1000 | 8 | 0.1 | 23 | 0.5 | 5.3 | 6.7 [1.14] | 6 |
| CEC(3.4, 0.70) | 71 | 1:20:1000 | 8 | 0.1 | 62 | 1 | 8.5 | 14.2 [1.03] | 11 |
| CEC(1 ,0.40) | 39 | 1:20:600 | 13.3 | 0.17 | 21 | 0.25 | 2.0 | 1.90 [1.06] | 1.7 |
| CEC(1, 0.78) | 78 | 1:20:600 | 13.3 | 0.17 | 78 | 1.0 | 4.6 | 4.39 [1.22] | 4.4 |
| CEC(100, 0.27)* | 26 | 1:20:12000 | 0.16 | 0.01 | 49 | 48 | 150 | n.a | 138 |

^{a}Reaction conditions: 100° C..
^{b}Nomenclature CEC(M_{n,PEO}, f_{PC}) where M_{n,PEO} is the number-average molecular mass defined by the manufacturer and verified by SEC and f_{PC} is the volume fraction of PC:
$determined as 1- {f}_{PEO} and {f}_{PEO} = \frac{{v}_{PEO}}{{v}_{PEO} + \frac{{M}_{PC} {M}_{EO}}{{M}_{C} {M}_{PEO}} {v}_{PC}} where {M}_{EO} and {M}_{C} are the molar masses of EO ( 44.05$ g mol⁻¹) and vCHO/CO₂ (168.23 g mol⁻¹), respectively. M_{PEO} and M_{PC} are the number averaged molecular weights of the PEO and PC blocks in kg mol⁻¹. Molar volumes V_{PEO}, V_{PC} were calculated by v = M/ρ using densities (g cm⁻³) of PC and PEO of 1.10 g cm⁻³ and 1.12 g cm⁻³.
^{c}Determined by relative ¹H NMR integration of PEO (3.64 ppm) vs PC (5.75 or 2.42 ppm) using PC repeat unit of 168.23 g mol⁻¹.
^{d}Catalyst loading (catalyst/epoxide).
^{e}vCHO conversion to PC determined from 1H NMR analysis of crude reaction mixture.
^{f}Reaction time.
^{g}Overall theoretical molar mass, Mₙ calculated based on initial monomer/initiator ratio, M_{n,PEO} and conversion of vCHO to PC. Mₙ and dispersity ( [symbol] ) by SEC measured with CHCl₃ eluent,
RI detection and vs narrow polystyrene standards. Mₙ by NMR is determined by relative integration of the PEO and PC environments and taking into account M_{n,PEO} of the macroinitiator.
*Conducted in stainless steel reactor at 40 bar CO₂ pressure.

Radical mediated thiol-ene ‘click’ chemistry can be used to introduce functional groups to polymer backbones with high efficiency. Phosphonic —PO(OH)₂ functional groups were grafted onto the polycarbonate blocks to tailor adhesive properties (FIG. 2a-ii). They were chosen as established ligands for coordination, possessing multiple binding modes. Phosphonic acids are anticipated to bind more strongly than carboxylic acids. Functionalized polymers were purified by precipitation from diethyl ether, and the extent of grafted 2-mercaptoethyl phosphonic acid (MEPA) was monitored by loss of the alkene environment in the ¹H NMR spectra and appearance of new signals assigned to the newly attached MEPA (FIG. 7). To avoid potential processing difficulties, the PC block was only partially functionalized (<10 wt %) using sub-stoichiometric MEPA quantities (FIG. 8). ¹H NMR spectroscopy of the partially MEPA grafted polymers showed that the integral ratio of the vinyl environment (5.75 ppm) to PEO signal (3.64 ppm) and new thiol environment at ˜2.72 ppm were consistent (FIG. 9). SEC analysis of the partially functionalized polymers (<3 wt % MEPA) was possible and indicated no high molar mass fractions that would indicate crosslinking (FIG. 10). A single phosphorus environment (−28 ppm) was confirmed by ³¹P NMR and typical absorptions of —PO(OH)₂ by FTIR (FIG. 11). MEPA content was optimized at 6 wt %, and subsequently, polymers are called CEC(Mₙ,_{PEO}, f_{PC}).

PC/PEO microphase separation into physically crosslinked 3D networks is anticipated and illustrated in FIG. 2b depicting a spherical morphology of rigid PC domains in a PEO matrix. Thin-film solid polymer electrolytes (SPEs) were prepared by mixing the polymer with lithium bis(trifluoromethanesulfonyl)imide (LiTFSI) salt using a solvent casting technique. LiTFSI was chosen as a common salt to the field owing to its high thermal stability. The polymer and lithium salt were dissolved in anhydrous THF in a glovebox before being poured into a Teflon mold, and the solvent allowed to evaporate. The resulting standalone polymer films were dried in a vacuum oven at 60° C. for 72 h (FIG. 12).

In FIG. 2d, DSC analysis of CEC(35,0.26)/LiTFSI films shows that adding LiTFSI disrupts the crystallinity of the PEO segment, indicated by the loss of melting point. Two glass transition temperatures, attributed to the PEO (T_{g}=−46 to −37° C.) and PC blocks (100-112° C.), signify that the salt enhances phase separation behaviour. For example, at 22 wt % LiTFSI, the PEO crystallinity (χ_{c}) is roughly half (χ_{c} 13%, Tₘ 42° C.) compared to when no salt is present (χ_{c} 37%, Tₘ 47° C.). Further addition of LiTFSI (25 wt %) is sufficient to completely eliminate PEO crystallinity with only glass transitions observable at −43 and 102° C. Evidence of phase separation into hard PC and soft amorphous PEO domains, which is important for mechanical properties, illustrates the utility of the electrolytes. Furthermore, ionic conductivity is known to occur predominantly through amorphous PEO regions. Continued addition of salt led to further increases in the T_{g} of the PEO domain, reflecting restricting chain mobility. Similar DSC behavior with wt % LITFSI was observed for the other polymers in the series (FIG. 13). Unlike PEO/LiTFSI systems, the upper T_{g} due to the rigid PC block signals the temperature up to which polymers remain mechanically stable (see later) and thus is important for the battery operating window. At fixed salt content, T_{g,PEO} and PEO crystallinity decreased with increasing f_{PC}, whereas T_{g, PC} increased as expected (FIG. 13).

Li-ions can coordinate to both the carbonate groups and PEO ethereal oxygens. The presence of Li in the PC domains and PEO mid-segments was corroborated by FTIR spectroscopy of the SPE films whereby a broadening of the carbonate C═O stretch and a shift to lower wavenumbers (1744-1739 cm⁻¹) with 0-66 wt % LiTFSI was observed (FIG. 2d). ⁷Li NMR of the polymer electrolytes dissolved in CDCl₃ shows a single Li-environment at −0.5 ppm for CEC(35,0.26)/28 wt % LiTFSI analogous to PEO/LITFSI consistent with Li-ions preferentially residing in the PEO phase at lower salt content (FIG. 14) In contrast CEC(35,0.70)/66 wt % LITFSI and CEC(8,0.37)/26 wt % LiTFSI with lower Mₙ PEO (8 kg mol⁻¹) show environments between PC/LiTFSI at −0.7 ppm and PEO/LITFSI.

### Adhesion

MEPA functional groups were introduced along the backbone of the hard PC domains to improve adhesion via coordination or hydrogen bonding to active inorganic materials. Adhesion plays a role in maintaining interfacial contact between the active materials in the composite cathode; loss of contact during continuous volume changes of the active material leads to degradation of the electrochemical performance. Poor adhesion can thus result in capacity loss and low long-term battery stability. Adhesion occurs through wetting of the polymer electrolyte on the surface of the active inorganic material. Typically, this occurs when the surface energy of the polymer is less than that of the inorganic solid. The surface energy of the polymer electrolyte films was measured using Owens/Wendt Theory and in all cases, the polymers would be expected to wet the surface of the inorganic cathode material (Table 2).

TABLE 2
Surface Energy Measurements

| Polymer/r = 13 | wt % g-MEPA | Surface Free Energy (mJ m⁻²) |
|---|---|---|
| CEC(35, 0.70) | 6 | 40.5 |
| CEC(35, 0.55) | 6 | 33.9 |
| CEC(35, 0.26) | 6 | 13.2 |
| CEC(35, 0.37) | 0 | 48 |
| CEC(35, 0.37) | 3 | 44 |
| CEC(35, 0.37) | 6 | 39 |
| NMC | n.a | 760 to 2270 |

Wetting of polymer on surface of cathode material: γ_{polymer}<γ_{active material}. Contact Angle Approach using Owens/Wendt Theory with water, glycol and diiodomethane.

$${σ}_{S L} = {σ}_{S} + {σ}_{L} - 2 {( {σ}_{L}^{D} {σ}_{S}^{D} )}^{1 / 2} - 2 {( {σ}_{L}^{P} {σ}_{S}^{P} )}^{1 / 2}$$

$${σ}_{S} = {σ}_{S L} + {σ}_{L} cos θ$$

where σ_{L}/σ_{S}=overall surface tension of the wetting liquid/overall surface energy of the solid, σ_{L/S}^{D}=dispersive component of the surface tension of the wetting liquid/surface energy of the solid; σ_{L/S}^{P}=polar component of the surface tension of the wetting liquid/surface energy of the solid; σ_{SL}=the interfacial tension between the solid and the liquid, and θ=the contact angle between the liquid and the solid.

180° peel tests were used to gauge the adhesive capabilities of the SPEs to the cathode material using alumina as a model substrate for the oxide cathode surface (FIG. 15b).^{24,25} Solutions of CEC(35,0.0.37) with 0, 1, 3, and 6 wt % grafted MEPA were coated onto the substrate using a doctor blade (100 μm thickness). The force required to peel the polymer film away from the oxide surface (FIG. 15c) was measured and correlated to a peel strength. Grafting 6 wt % MEPA showed 11×greater peel strength than PEO homopolymer (FIG. 15d). The impact of LiTFSI, PEO midblock length and f_{PC} on adhesion were also investigated (FIG. 16). Increasing f_{PC} resulted in less adhesive films. Lower f_{PC} or high MEPA wt % resulted in tacky films.

FTIR was used to probe the binding of the phosphonic acid grafted polymer to the actual NMC cathode surface (FIG. 15e). As a model, pure polycarbonate that was 100%-MEPA grafted was used to discern any interactions. The polymer was mixed with NMC cathode particles and the FTIR of the coated particles compared to the polymer. FIG. 15e highlights the region characteristic of P—O stretching frequencies. A significant change can be observed between the MEPA-grafted polymer in the 900-1000 cm⁻¹ subregion and the polymer on the cathode surface. The latter shows a broad absorption, whereas the free phosphonic acids in PC-g-MEPA show two absorptions attributed to asymmetric and symmetric P—O—(H) stretches. This change supports hydrogen bonding interactions to the surface, and a new absorption at 1065 cm⁻¹ is typical of monobasic PO₂⁻ anion. There are multiple binding modes of phosphonic acids to metal oxide surfaces, including hydrogen-bonding, monobasic and dibasic anion, mono-, di- and tridentate coordination. The presence of the P═O stretching vibrations at 2040 cm⁻¹, which is expected to disappear in tridentate coordination, might suggest a mixture of hydrogen bonding interactions and mono plus bi-dentate binding modes. An SEM image of the 6 wt % MEPA grafter PC-PEO triblock polymer mixed with NMC particles (3 wt % polymer) shows polymer (FIG. 15f).

### Li-Ion Conductivity

Electrochemical impedance spectroscopy (EIS) was used to measure the ionic conductivities of polymer electrolytes. Films were punched into discs with 0.09-0.45 mm thicknesses, measured by digital microscopy (Table 3). Measurements were performed as a function of temperature (RT-80° C.) and LiTFSI content. For CEC(35,0.37), an optimal 28 wt % LiTFSI content was determined or a Li-ion to every 13 EO or carbonate coordinating environments: r=[EO+CO]/[Li]=13 (FIG. 17). For comparison, the optimal salt content reported for PEO/LiTFSI systems is [EO]/[Li]=10-12. At this same salt content, a series of polymer electrolytes with PEO segments of Mₙ 35 kg mol⁻¹ differing in f_{PC} (0.26-0.70) were investigated (FIG. 18a). The trend of decreasing ionic conductivity with increasing f_{PC} is likely due to increasing physical crosslinking (due to PEO/PC microphase separation) restricting PEO chain mobility. A similar effect was observed for polymers with increasing MEPA content (FIG. 19), where additional ionic/hydrogen-bonding crosslinking of the polycarbonate domains further restrict motion of Li-ions in the main PEO conducting phase.²⁶ The trend favouring lower f_{PC} benefits elastomeric properties, which typically comprise hard domain volume fractions <0.30. Importantly, the RT ionic conductivity at f_{PC}=0.26 is higher than PEO and PS-b-PEO/LiTFSI systems (Table 5) and may be rationalized based on the absence of PEO crystallinity and potential for conductivity in the PC phase.

TABLE 3
SPE Film Thickness Measurements

| | Film Thickness from |
|---|---|
| CEC(35, 0.37)/r= | Digital Microscope (μm) |
| 11 | 79.9 ± 1.5 |
| 13 | 91.6 ± 1.2 |
| 16 | 92.2 ± 1.3 |
| 18 | 83.6 ± 1.2 |
| 21 | 130.8 ± 1.0 |

Film thickness is important for determining conductivity from impedance data and for measuring mechanical properties. To verify accurate film thicknesses Keyence VHX 7000 Digital Microscope (14 measurements over 2 cross-sections) was used and values correlated to those obtained using calipers (3 measurements).

As hypothesized, the block polymers show higher oxidative stability with increasing f_{PC} (vs Li+/Li with SS counter-electrode, FIG. 20). This parameter is important for materials in a composite cathode. Subsequently, higher salt loadings were investigated to improve the ionic conductivity of CEC(35,0.70), which showed the best oxidative stability. At 66 wt % LiTFSI (r=2), conductivities of 2.5×10⁻³ S cm⁻¹ at 60° C. were achievable for CEC(35,0.70) (FIG. 20b). Such high salt contents offered other advantages in terms of lithium transference numbers, tensile toughness and stability again sulphide solid electrolytes (vide infra). Films formed with CEC(35,0.26) at these high salt contents were less stable. Lower MW PEO mid-blocks showed higher conductivities (FIG. 20c). This behaviour contrasts with that observed for PS-PEO systems, believed to result from less influence at higher MW of a dead zone excluding Li-ion transport at the PS/PEO interface Higher MW PEO mid-segments (100 kg mol⁻¹) were thus not assessed further.

Typically, the temperature dependence of lithium-ion conductivity follows the Vogel-Tamman-Fulcher (VTF) model:

$${σ}_{L i +} = {AT}^{- 1 / 2} exp ( \frac{- {E}_{a}}{R ( T - {T}_{0}} )$$

where T₀=T_{g}−50K and parameters A (relating to the free charge carrier concentration) and Eₐ (activation energy for ion transport) can be obtained by a linear fit. Generally, increasing f_{PC} or grafted MEPA content (i.e. physically crosslinking) had little impact on Eₐ, but a larger influence on A. Whereas, increasing salt content and PEO MW influenced both Eₐ and A (FIG. 21). VTF plots are shown for the three most conductive polymer films from FIG. 18a-c: CEC(35,0.26)/28 wt %, CEC(35,0.70)/66 wt % and CEC(8,0.36)/26 wt % LiTFSI, now referred to as P1, P2 and P3 (FIG. 18d). The extracted Eₐ and A values can be used to rationalize the trend in ionic conductivity for the lead polymers: P3>P2>P1. P3 has the highest concentration of free charge carriers (A), and P2 has the lowest activation energy for ion transport. Overall, the Eₐ values of 9.6-14.6 kJ mol⁻¹ are comparable with lithium salts in amorphous PEO (low MW or high T).

Solid-state ⁷Li NMR for P1-P3 shows increasingly downfield shifts following the same order as conductivity (FIG. 18e). This shift coincides with more PC—Li environment contribution and presumably less restricted ion movement for P3. Pulsed-field-gradient NMR of the solid-state samples at 60° C. measured the diffusion coefficient of ⁷Li cation and ¹⁹F anion (FIG. 22). In contrast, P3 showed the slowest Li-ion diffusivity P2>P1>P3 (Table 4), reflecting the trend in activation energies. The lithium-ion transference number (t_{Li+}) or contribution of Li-ions to the total conductivity was subsequently determined based on the mobility of the cation and anion. P2 showed the highest transference number of 0.62, as is often observed for high salt loadings (FIG. 18f). PC higher permittivity and weaker coordination to Li than ether rationalized as reason for higher t_{Li+} observed for PC. Hydrogen bonding to the anion (i.e. MEPA) has also been reported to retard anion migration, increasing t_{Li+}.²⁷ Values are provided in Table 5 and compared to PEO, PC/EO and PS-PEO systems.

P1-P3 block copolymers show higher conductivities than random PC/EO copolymers reported in the literature (Table 1). This observation might suggest a role played by the phase-separated morphologies providing channels for ion movement. SAXS profiles conducted of the polymer electrolyte films at RT suggests some long-range ordering with hexagonally packed cylinders or FCC spherical morphologies of PC in a PEO matrix for P1 and P3, with domain spacings (D) based on the principal scattering peak (q*) of 24 and 36 nm, respectively (FIG. 22a). P2 has a mixed morphology with a domain spacing of 38 nm. The full width at half maximum (FWHM) of q* can be related to the grain size (G): G^{˜}1/FWHM based on the Scherrer equation, with smaller grain sizes associated with higher ionic conductivities. Accordingly, based on this analysis, P1 with the lowest conductivity can be estimated to have grain sizes nearly twice that for P2 and P3 (FIG. 21e).

TABLE 4
Diffusion PFG-NMR

| | ⁷Li Diff | | ¹⁹F Diff | |
|---|---|---|---|---|
| Polymer | (m² s⁻¹) | Error | (m² s⁻¹) | Error |
| P1 | 3.344E−12 | 1.071E−13 | 6.655E−12 | 3.909E−14 |
| P2 | 6.248E−11 | 5.418E−13 | 3.881E−11 | 5.397E−13 |
| P3 | 2.824E−12 | 3.006E−13 | 4.535E−12 | 2.369E−13 |

### Mechanical Properties

Initial investigations focused on the behavior of the SPEs under tension. Dumbbell specimens for tensile testing experiments were cut from solid polymer electrolytes films according to specimen type-5B ISO standard 527-2. The Young's Modulus (E_{y}) was determined from the initial linear stress-strain region (0.025-0.25% strain). All samples were stored in a glovebox prior to testing to minimize the influence of water ingress on the mechanical properties FIG. 23b shows representative stress-strain curves for P1-P3 (see FIG. 24-26 for others and influence of salt content). Both P1 and P3 show typically elastomer behavior (linear stress-strain behaviour). P1 in particular (FIG. 23c) shows excellent elastic recovery (98.3±0.2%) at 200% strain, high resilience (91.6±0.9%) and minimal residual strain (3.5±0.5%). High elasticity was anticipated to be beneficial when using the SPE as a binder in the composite cathode to accommodate volume change. Tensile toughness increases with LiTFSI for P2 (FIG. 24). Behaviour under compression (FIG. 23d) investigated as battery under pressure and NMC811 contacts on delithiated. P1-P3 show low creep rates under a compressive stress of 1 MPa (10⁻⁴/10⁻⁵ s⁻¹, FIG. 27).

Mechanical properties for P1-P3 were also investigated by rheology in the linear viscoelastic region (determined by an amplitude sweep at 1 Hz). FIG. 23e shows the storage (G′) and loss moduli (G″) for the polymer electrolytes from 30 to 140° C. under isochronal conditions (ω=1 Hz, 0.1% amplitude strain). Noticeably G′ is greatest for P2>P1>P3 as anticipated based on its high f_{PC} and lower Mₙ for P3. For P1, G′>G″ over a wide temperature window and largely independent: it is in the rubbery plateau region (Mₑ=ρRT/G=3.4 kg mol⁻¹ using ρ_{PEO}=1.12 g cm⁻³). P3 follows WLF behaviour and shows a crossover point at 74° C., making it attractive for ease of processability. There is also frequency dependence of G′, G″ which may be important when considering the rate of volume change of the cathode material. Over the frequency range measured (0.1 to 10 Hz), G′ and G″ increase with frequency (w), the precise dependence varied with polymer electrolyte but at 60° C., G′>G″ in all cases indicating a dominant elastic mechanical response (FIG. 28). It is important to note that thermogravimetric analysis (TGA) indicated polymer electrolytes were stable to decomposition up to 230° C. (FIG. 30).

TABLE 5
Summary of key electrochemical and mechanical data.^{a}

| Polymer | T_{g1}, T_{g2} | σ (S cm⁻¹)^{b} | | G′ | |
|---|---|---|---|---|---|
| Electrolyte | (° C.)^{a} | 30° C. | 60° C. | (MPa)^{c} | t_{Li+}^{d} |
| P1 | −40, 105 | 1.0 × 10⁻⁴ | 3.4 × 10⁻⁴ | 0.82 | 0.33 |
| P2 | −23, 90 | 2.3 × 10⁻⁴ | 2.5 × 10⁻³ | 67 | 0.62 |
| P3 | −45, 84 | 6.7 × 10⁻⁴ | 9.1 × 10⁻³ | 0.52 | 0.38 |

^{a}Glass transitions from DSC.
^{b}Ionic conductivity
^{c}Shear storage moduli at 30° C.
^{d}Lithium transference number at 60° C.

### Battery Performance

The cell performance of the three lead polymers were investigated. P1 is a typical thermoplastic elastomer, P2 is a polymer-in-salt composition with high G′, and P3 is a low-temperature melt-processable soft elastomer. Prior to cell fabrication, the oxidative stability of these lead polymers was evaluated by linear sweep voltammetry at a low scan rate of 0.1 mV s⁻¹ vs lithium and a carbon-polymer composite (FIG. 27a). Under these conditions, oxidative stability decreased in the order P3>P2>P1. Importantly, all are improved compared to PEO homopolymer (<3.5 V).

Composite cathodes were prepared with P1, P2 and P3 with carbon nanofibers for electrical conductivity, polycrystalline NMC811 high-voltage cathode material and LPSCI ceramic electrolyte. The powders were homogeneously mixed by ball-milling and formed into a pellet by cold-pressing (50 MPa). Although there remain questions of scalability of the dry mixing method, the use of solvents resulted in higher degradation of LPSCI and with an ionically conductive polymer, concerns regarding partially blocked ion conduction pathways when dry mixing non-conducting binders are lessened. The cell was assembled: LTO|LPSCI|SPE-NMC composite cathode and charged-discharged at 60° C., 1 MPa stack pressure, 0.5 C rate.

Initial discharge capacity shows P2 and P3 give capacities higher than no-polymer (P0), PEO and P1 (FIG. 27b). This result is rationalized based on their higher conductivities than P1 and more retention of solid-solid contacts after removing the 50 MPa used for cell densification. The performance over multiple charge-discharge cycles was subsequently evaluated (FIG. 27c). Capacity retention is determined as the discharge capacity at cycle n relative to the initial discharge capacity and relates to long term battery stability. Elastic P1 showed the highest capacity retention (86% after 200 cycles) compared to P2 (79%), P3 (83%) and no-polymer (73%) despite its initial lower capacity. Nevertheless, due to the drop in capacity for the no polymer set-up, after 100 cycles, P1 retains a higher capacity. The extremely poor longevity when using PEO homopolymer can be attributed to its lower oxidative stability than P1-P3 but more likely its chemical reactivity with the sulfide-solid-state electrolyte.

### Stability vs Argyrodite (LPSCI)

Despite its high conductivity advantages, Li₆PS₅Cl argyrodite electrolyte (LPSCI) is highly reactive, and its conductivity is dependent on the crystal structure. To assess the chemical stability of the polymer electrolytes vs Li₆PS₅Cl, conductivity measurements were conducted (by electrochemical impedance spectroscopy) of polymer electrolytes sandwiched between LPSCI (SPE|LPSCI|SPE). The cell was heated at 60° C., and impedance measurements were recorded at regular 10 h intervals at RT (the lower temperature to evaluate differences between the polymers). Whereas PEO shows increasing resistance with time, indicating chemical reactivity and degradation of LPSCI as noted previously by Janek et al, P2 decreases. After 10 days at 60° C., little difference in conductivity behaviour was observed, indicating good chemical stability vs LPSCI (FIG. 27d). This stability might be attributed to the high lithium salt content of the polymer electrolyte.

While specific embodiments of the invention have been described herein for the purpose of reference and illustration, various modifications will be apparent to a person skilled in the art without departing from the scope of the invention as defined by the appended claims.

### REFERENCES

1. Patel, S. N., 100th Anniversary of Macromolecular Science Viewpoint: Solid Polymer Electrolytes in Cathode Electrodes for Lithium Batteries. Current Challenges and Future Opportunities. ACS Macro Lett. 2021, 10 (1), 141-153.
2. 1. Kim, K. J.; Balaish, M.; Wadaguchi, M.; Kong, L.; Rupp, J. L. M., Solid-State Li-Metal Batteries: Challenges and Horizons of Oxide and Sulfide Solid Electrolytes and Their Interfaces. Adv. Energy Mater. 2021, 11 (1), 2002689.
3. 1. Lopez, J.; Mackanic, D. G.; Cui, Y.; Bao, Z., Designing polymers for advanced battery chemistries. Nature Rev. Mater. 2019, 4 (5), 312-330.
4. Wang, J.; Li, S.; Zhao, Q.; Song, C.; Xue, Z., Structure Code for Advanced Polymer Electrolyte in Lithium-Ion Batteries. Adv. Funct. Mater. 2020, 31 (12), 2008208.
5. Sen, S.; Trevisanello, E.; Niemöller, E.; Shi, B.-X.; Simon, F. J.; Richter, F. H., The role of polymers in lithium solid-state batteries with inorganic solid electrolytes. J. Mater. Chem. A 2021, 9 (35), 18701-18732.
6. Sen, S.; Trevisanello, E.; Niemöller, E.; Shi, B.-X.; Simon, F. J.; Richter, F. H., The role of polymers in lithium solid-state batteries with inorganic solid electrolytes. J. Mater. Chem. A 2021, 9 (35), 18701-18732.
7. Mecerreyes, D.; Porcarelli, L.; Casado, N., Innovative Polymers for Next-Generation Batteries. Macromol. Chem. Phys. 2020, 1900490.
8. Forsyth, M.; Porcarelli, L.; Wang, X.; Goujon, N.; Mecerreyes, D., Innovative Electrolytes Based on Ionic Liquids and Polymers for Next-Generation Solid-State Batteries. Acc. Chem. Res. 2019, 52 (3), 686-694.
9. Hong, S.; Wang, Y.; Kim, N.; Lee, S. B., Polymer-based electrolytes for all-solid-state lithium-sulfur batteries: from fundamental research to performance improvement. J. Mater. Sci. 2021, 56 (14), 8358-8382.
10. Li, J.; Cai, Y.; Wu, H.; Yu, Z.; Yan, X.; Zhang, Q.; Gao, T. Z.; Liu, K.; Jia, X.; Bao, Z., Polymers in Lithium-Ion and Lithium Metal Batteries. Adv. Energy Mater. 2021, 11 (15), 2003239.
11. Janek, J.; Zeier, W. G., A solid future for battery development. Nat. Energy 2016, 1 (9), 16141.
12. Koerver, R.; Zhang, W.; de Biasi, L.; Schweidler, S.; Kondrakov, A. O.; Kolling, S.; Brezesinski, T.; Hartmann, P.; Zeier, W. G.; Janek, J., Chemo-mechanical expansion of lithium electrode materials—on the route to mechanically optimized all-solid-state batteries. Energy Environ. Sci. 2018, 11 (8), 2142-2158.
13. Bielefeld, A.; Weber, D. A.; Janek, J., Modeling Effective Ionic Conductivity and Binder Influence in Composite Cathodes for All-Solid-State Batteries. ACS Appl. Mater. Interfaces 2020, 12(11), 12821-12833.
14. Cholewinski, A.; Si, P.; Uceda, M.; Pope, M.; Zhao, B., Polymer Binders: Characterization and Development toward Aqueous Electrode Fabrication for Sustainability. Polymers 2021, 13 (4), 631.
15. Mecerreyes, D.; Porcarelli, L.; Casado, N., Innovative Polymers for Next-Generation Batteries. Macromol. Chem. Phys. 2020, 221 (4), 1900490.
16. Shi, Y.; Zhou, X.; Yu, G., Material and Structural Design of Novel Binder Systems for High-Energy, High-Power Lithium-Ion Batteries. Acc. Chem. Res. 2017, 50 (11), 2642-2652.
17. Ma, Y.; Ma, J.; Cui, G., Small things make big deal: Powerful binders of lithium batteries and post-lithium batteries. Energy Storage Materials 2019, 20, 146-175.
18. Isozumi, H.; Horiba, T.; Kubota, K.; Hida, K.; Matsuyama, T.; Yasuno, S.; Komaba, S., Application of modified styrene-butadiene-rubber-based latex binder to high-voltage operating LiCoO2 composite electrodes for lithium-ion batteries. Journal of Power Sources 2020, 468, 228332.
19. 1. Bucci, G.; Talamini, B.; Renuka Balakrishna, A.; Chiang, Y.-M.; Carter, W. C., Mechanical instability of electrode-electrolyte interfaces in solid-state batteries. Phys. Rev. Mater. 2018, 2 (10).
20. Bresser, D.; Lyonnard, S.; lojoiu, C.; Picard, L.; Passerini, S., Decoupling segmental relaxation and ionic conductivity for lithium-ion polymer electrolytes. Mol. Syst. Des. Eng. 2019, 4 (4), 779-792.
21. Ding, W.-Q.; Lv, F.; Xu, N.; Wu, M.-T.; Liu, J.; Gao, X.-P., Polyethylene Oxide-Based Solid-State Composite Polymer Electrolytes for Rechargeable Lithium Batteries. ACS Appl. Energy Mater. 2021, 4 (5), 4581-4601.
22. Spyros, A.; Argyropoulos, D. S.; Marchessault, R. H., A Study of Poly(hydroxyalkanoate)s by Quantitative 31P NMR Spectroscopy: Molecular Weight and Chain Cleavage. Macromolecules 1997, 30 (2), 327-329.
23. A. C. Deacy, A. F. R. Kilpatrick, A. Regoutz and C. K. Williams, Nature Chemistry, 2020, 12, 372-380.
24. Lee, K.; Lee, J.; Choi, S.; Char, K.; Choi, J. W., Thiol-Ene Click Reaction for Fine Polarity Tuning of Polymeric Binders in Solution-Processed All-Solid-State Batteries. ACS Energy Lett. 2019, 4 (1), 94-101.
25. Mackanic, D. G.; Yan, X.; Zhang, Q.; Matsuhisa, N.; Yu, Z.; Jiang, Y.; Manika, T.; Lopez, J.; Yan, H.; Liu, K.; Chen, X.; Cui, Y.; Bao, Z., Decoupling of mechanical properties and ionic conductivity in supramolecular lithium ion conductors. Nature Commun. 2019, 10 (1), 5384.
26. Hasan, N.; Pulst, M.; Samiullah, M. H.; Kressler, J., Comparison of Li+-ion conductivity in linear and crosslinked poly(ethylene oxide). J. Polym. Sci. Part B: Polym. Phys. 2019, 57 (1), 21-28.
27. Jo, G.; Jeon, H.; Park, M. J., Synthesis of Polymer Electrolytes Based on Poly(ethylene oxide) and an Anion-Stabilizing Hard Polymer for Enhancing Conductivity and Cation Transport. ACS Macro Lett. 2015, 4 (2), 225-230.

1. A polymer having a structure according to Formula I:
A-B-A (I)
wherein
A is a polycarbonate block; and
B is a polyether block.

2. The polymer of claim 1, wherein the polyether block B comprises m number of repeating units and each polycarbonate block A comprises n number of repeating units, wherein m is 5-10,000 and n is 1 to 1000.

3. The polymer of claim 1 or 2, wherein block A has a glass transition temperature (T_{g}) that is ≥20° C. (e.g. 20-120° C.).

4. The polymer of claim 1, 2 or 3, wherein block B has a glass transition temperature (T_{g}) that is ≤20° C. (e.g. −60 to 20° C.).

5. The polymer of any one of the preceding claims, wherein block A has a glass transition temperature (T_{g}) that is 90-115° C. and block B has a glass transition temperature (T_{g}) that is −50 to −30° C.

6. The polymer of any one of the preceding claims, wherein block B has a molecular weight (Mₙ) of 3-110 kg mol⁻¹ and the polymer comprises 10-80 wt % of block A.

7. The polymer of any one of the preceding claims, wherein
(A) block B has a molecular weight (Mₙ) of 5-45 kg mol⁻¹ or 6-12 kg mol⁻¹; and/or
(B) the polymer comprises 20-40 wt % or 50-75 wt % of block A.

8. The polymer of any one of the preceding claims, wherein
(A) block B has a molecular weight (Mₙ) of 30-40 kg mol⁻¹ and the polymer comprises 60-80 wt % (e.g., 65-75 wt %) of block A; or
(B) block B has a molecular weight (Mₙ) of 30-40 kg mol⁻¹ and the polymer comprises 20-40 wt % (e.g., 22-30 wt %) of block A; or
(C) block B has a molecular weight (Mₙ) of 6-12 kg mol⁻¹ and comprises 25-55 wt % (e.g., 32-42 wt %) of block A.

9. The polymer of any one of the preceding claims, wherein a proportion of the A and/or B block repeating units independently comprises a pendant neutral functional group FG_{N} and/or a pendant anionic functional group FG_{A}, wherein FG_{N} is selected from —P(O)(OH)₂, —COOH, —OH, —SO₃H, —NH₂, —C(O)NH₂, —F, —CF₃ and —CN, and FG_{A} is selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃.

10. The polymer of any one of the preceding claims, wherein a proportion of the A block repeating units comprises a neutral functional group being —P(O)(OH)₂.

11. The polymer of any one of the preceding claims, wherein block A has a structure according to Formula A-i: 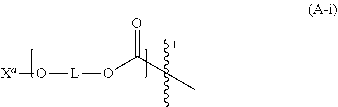
wherein [symbol]
¹ denotes the point of attachment to B;
X^{a} is an end group; and
L is a linking group separating the two oxygen atoms to which it is attached by a distance of 2-3 carbon atoms.

12. The polymer of any one of the preceding claims, wherein block A has a structure according to Formula A-ii: 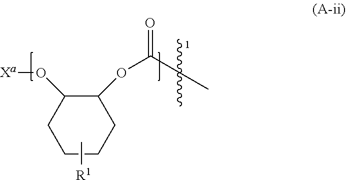
wherein [symbol]
¹ denotes the point of attachment to block B;
X^{a} is an end group; and
each R¹ is independently absent or a group —X—(R²)ᵥ, in which
each R² is independently a pendant neutral functional group FG_{N} or a pendant anionic functional group FG_{A} as claimed in claim 9 or 10;
each v is independently 0 or 1; and
each X is (when v is 1) a linking group (e.g. a divalent group) that links R² to the cyclohexyl ring, or is (when v is 0) a terminal (e.g., monovalent) group.

13. The polymer of claim 12, wherein R¹ is absent, or is

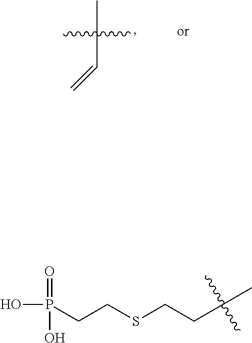

14. The polymer of any one of the preceding claims, wherein the polyether block B is composed of poly(ethylene oxide), poly(propylene oxide), poly(allyl glycidyl ether) or a copolymer of two or more thereof.

15. The polymer of any one of the preceding claims, wherein the polyether block B is composed of poly(ethylene oxide).

16. The polymer of any one of the preceding claims, wherein the polymer has a structure according to Formula (IB): 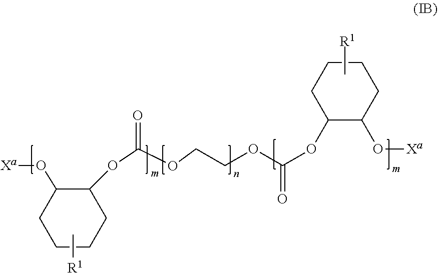
wherein
X^{a}, m and n are as defined in any one of the preceding claims; and
each R¹ is independently absent or a group —X—(R²)ᵥ, in which
each R² is independently a pendant neutral functional group FG_{N} or a pendant anionic functional group FG_{A} as claimed in claim 9 or 10;
each v is independently 0 or 1; and
each X is (when v is 1) a linking group that links R² to the cyclohexyl ring, or is (when v is 0) a terminal group.

17. A process for the preparation of a polymer, the process comprising the steps of:
(a) providing a polyether having a hydroxy terminal group at each end; and
(b) growing a polycarbonate on both ends of the polyether by ring-opening copolymerisation of:
(i) an epoxide or an oxetane, and (ii) carbon dioxide.

18. The process of claim 17, wherein the epoxide is a cyclic epoxide.

19. The process of any one of claims 17 to 18, further comprising the step of:
(c) modifying a proportion of the polycarbonate and/or polyether repeating units by introducing:
a pendant neutral functional group selected from —P(O)(OH)₂, —COOH, —OH, —SO₃H, —NH₂, —C(O)NH₂, —F, —CF₃ and —CN; and/or
a pendant anionic functional group selected from —PO₃²⁻, —PO₂(OH)⁻, —COO⁻, —SO₃⁻, —SO₂N⁻SO₂CF₃, —N⁻SO₂CF₃, —(CF₂)₂O(CF₂)₂SO₃⁻, —BO₄⁻, —(C₆H₄)₄B⁻, —(C₆F₄)₄B⁻ and —CHFCF₂SO₃⁻.

20. An electrolyte comprising a mixture of a polymer as claimed in any one of claims 1 to 16 and a metal salt.

21. The electrolyte of claim 20, wherein the metal salt is of the formula M⁺ X⁻, wherein M⁺ is selected from Na⁺, Li⁺ and K⁺, and X⁻ is selected from BF₄⁻, ClO₄⁻, bis(fluorosulfonyl)imide, bis(trifluoromethanesulfonyl)imide, bis(oxalato)borate, a perfluoroalkylsulfonate (e.g., CF₃SO₃⁻), a polyfluoroalkyl sulfontate, PF₆, AsF₆⁻, cyano(trifluoromethanesulfonyl)imide, bis[(pentafluoroethyl)sulfonyl]imide, B(CN)₄⁻, 4,5-dicarbonitrile-1,2,3-triazole, perylene diimide, 4,5-dicyano-2-(trifluoromethyl)imidazolium and combinations of two or more thereof.

22. The electrolyte of claim 21 wherein M⁺ is Li⁺ and/or X⁻ is bis(trifluoromethanesulfonyl)imide.

23. The electrolyte of any claim 20, 21 or 22, wherein the electrolyte comprises 0.1-80 wt % of the metal salt.

24. A cathode for a battery, the cathode comprising a polymer as claimed in any one of claims 1 to 16 or an electrolyte as claimed in any one of claims 20 to 23.

25. A battery comprising a polymer as claimed in any one of claims 1 to 16, an electrolyte as claimed in any one of claims 20 to 23, and/or a cathode as claimed in claim 24.
